(19) United States
(12) Patent Application Publication
(10) Pub. No.: US 2013/0122410 A1
(43) Pub. Date: May 16, 2013

(54) ELECTROPHOTOGRAPHIC PHOTOCONDUCTOR, AND IMAGE FORMING METHOD, IMAGE FORMING APPARATUS, AND PROCESS CARTRIDGE FOR IMAGE FORMING APPARATUS USING THE ELCTROPHOTOGRAPHIC PHOTOCONDUCTOR

(71) Applicants: Kazukiyo Nagai, Shizuoka (JP); Tetsuro Suzuki, Shizuoka (JP); Hongguo Li, Shizuoka (JP)

(72) Inventors: Kazukiyo Nagai, Shizuoka (JP); Tetsuro Suzuki, Shizuoka (JP); Hongguo Li, Shizuoka (JP)

(21) Appl. No.: 13/812,664

(22) PCT Filed: Jul. 29, 2011
(86) PCT No.: PCT/JP11/67921

§ 371 Date: Jan. 28, 2013

(30) Foreign Application Priority Data
Jul. 30, 2010 (JP) 2010-172542

(51) Int. Cl. G03G 5/06

(52) U.S. Cl. CPC G03G 5/0648
USPC 430/58.5; 430/125.3

(57) ABSTRACT

An electrophotographic photoconductor including a conductive support, a charge generating layer, a hole transporting layer, and a hole transporting-protective layer, these layers being laminated in this order on the conductive support, wherein the hole transporting-protective layer contains a three-dimensionally crosslinked product which is obtained through chain polymerization of at least a radical polymerizable hole-transporting compound by irradiating the radical polymerizable hole-transporting compound with an active energy beam, and wherein the hole transporting-protective layer contains an oxazole compound represented by General Formula (1) or (2) below:

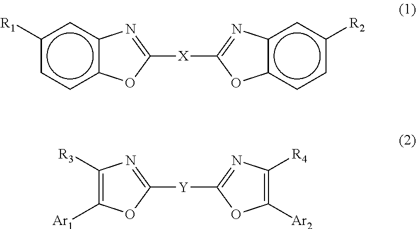

### TECHNICAL FIELD

The present invention relates to an image forming method and an image forming apparatus each of which employs an electrophotographic process allowing on-demand printing in the commercial printing field, and electrophotographic photoconductor and an a process cartridge for image forming apparatus used therefor.

### BACKGROUND ART

Recently, electrophotographic image forming apparatuses which were widely diffused in offices are becoming widely used in the commercial printing field because of their easy on-demand printing. In the commercial printing field, high-speed printing, a large output printing, high quality image, paper responsiveness and low production cost of printed matters are desired more than ever.

To achieve high speed printing, mass output printing and low production cost of printed matters, there is a need for electrophotographic photoconductors, which are main devices for electrophotography, to have a long operating life. As for photoconductors, there are used inorganic photoconductors typified by amorphous silicon, and organic photoconductor containing an organic charge-generating material and an organic charge-transporting material. It is understood that organic photoconductors are advantageous for the following reasons: (I) optical properties such as the wideness of light absorption wavelength ranges, and large light absorption amount, (II) electric properties such as high photosensitivity, and stable charging properties, (III) wide selection of materials, (IV) ease of production, (V) low production cost, and (VI) nontoxicity. On the other hand, organic photoconductors are weak against scratches and abrasion. Scratches cause defects, and abrasion lead to degradation of photosensitivity and chargeability and leakage of charges to cause abnormal images such as degradation in image density and background smear.

As a unit for improving the scratch resistance and abrasion resistance of organic photoconductors, there has been proposed a photoconductor in which a mechanically tough protective layer is formed on a conventional organic photoconductor. For example, PTL 1 proposes a photoconductive layer containing a compound which is obtained by curing a hole-transporting compound having two or more chain polymerizable functional groups in the same molecule.

Further, PTLs 2, 3 and 4 each propose a photoconductor having a protective layer formed into a crosslinked film which is obtained by irradiating, with an ultraviolet ray, a composition in which a radical polymerizable charge-transporting compound, a trifunctional or higher radical polymerizable monomer and a photopolymerization initiator are mixed. Since this photoconductor has excellent scratch resistance and abrasion resistance as well as excellent environmental stability, it enables stable image output without using a drum heater.

Furthermore, to prevent degradation in electric properties due to ultraviolet ray irradiation to the photoconductor having the crosslinked film as a protective layer, PTL 5 proposes to incorporate an ultraviolet ray absorbent into the crosslinked film to thereby prevent degradation of photosensitive materials during production of photoconductors.

These examinations show that a photoconductor having a three-dimensionally crosslinked protective layer in which a radical polymerizable charge-transporting compound (especially, a charge-transporting compound having an acrylic group) is singularly used or mixed with another acrylic monomer has excellent scratch resistance and abrasion resistance as well as excellent electric properties as a photoconductor and is suitable for commercial printing where a large volume of printing is performed. In the recent commercial printing field, however, high image quality has become desired more than ever before. Therefore, there is a need to reduce potential displacement of photoconductors with time during printing and potential nonuniformity inside surfaces of photoconductors as much as possible. The above-mentioned photoconductors do not have sufficient properties to meet the necessities.

To form a protective layer having a high crosslink density through a radical reaction, it is necessary to employ a method of incorporating a photodegradable radical polymerization initiator into the protective layer and irradiating with light (especially, ultraviolet ray), or to irradiate the protective film with an electron beam or radioactive ray having higher energy than ultraviolet ray to directly excite the acrylic group to thereby initiate polymerization. It can be considered that as a cause of the potential displacement and potential nonuniformity, in either cases, since the charge-transporting compound in the protective layer is excited at the same time, part of the charge-transporting compound is decomposed, and the decomposed matter degrades the charge transporting function which is an important function as a photoconductor.

In order to suppress the decomposition of such a charge-charge transporting material in an attempt to solve the above-mentioned problems, for example, it is considered to incorporate an ultraviolet ray absorbent into a protective layer as proposed in PTL 5. However, addition of a conventionally known ultraviolet ray absorbent brings large side effects to the charge-transporting function, which may cause a problem that the charge-transporting function of a photoconductor significantly degrades, and a problem that it suppress the radical polymerization reaction at the same time and it is difficult to form a protective layer having a sufficient crosslink density. Therefore, incorporation of an ultraviolet ray absorbent into a protective layer of a photoconductor has not yet practically employed.

In addition, as an additive to suppress a decomposition reaction of pigment, singlet oxygen quenchers (e.g., a nickel dithiolate complex) have been known, however, when such a material is added to a protective layer, it brings such an adverse effect that the photoconductor loses photoconductivity at all, and thus it is impossible to use them.

It has been impossible to resolve the problems attributable to protective layers of photoconductors each having a photoconductor which is formed into a three-dimensionally crosslinked film by curing at least a radical polymerizable charge-transporting compound with an active energy beam such as ultraviolet ray and an electron beam and to meet the demand of high image quality desired in the commercial printing field (stability of image density with time in printing and the stability of density inside a surface of a photoconductor).

For this reason, developments of an electrophotographic photoconductor which has a protective layer having superior charge-transportability, sufficient scratch resistance and abrasion resistance and enables output of images having higher image quality than ever before, an image forming method, an image forming apparatus and a process cartridge for image forming apparatus, using the electrophotographic photoconductor have been desired.

### CITATION LIST

### Patent Literature

PTL1 Japanese Patent Application Laid-Open (JP-A) No. 2000-66425
PTL2 Japanese Patent Application Laid-Open (JP-A) No. 2006-113321
PTL3 Japanese Patent (JP-B) No. 4145820
PTL4 Japanese Patent Application Laid-Open (JP-A) No. 2004-302451

PTL5 Japanese Patent Application Laid-Open (JP-A) No. 2004-302452

### SUMMARY OF INVENTION

### Technical Problem

In a photoconductor in which a three-dimensionally crosslinked protective layer by irradiating a radical polymerizable charge-transporting compound and a radical polymerizable monomer, on a conventional multi-layered photoconductor, with an active energy beam such as ultraviolet ray and electron beam (that is, a photoconductor in which at least a charge-generating layer, a hole-transporting layer, a hole-transporting protective layer which is three-dimensionally crosslinked through radical polymerization are laminated in this order on a conductive support), an object of the present invention is to provide an electrophotographic photoconductor which enables outputting high quality images having less variations in image density with time in printing and in-plane density nonuniformity of printed matters, by further improving the charge transportability while the mechanical strength of the protective layer being maintained. Another object of the present invention is to provide an image forming method, an image forming apparatus and a process cartridge for image forming apparatus, each of which uses the electrophotographic photoconductor and is excellent in high image quality, longer operating life and cost performance.

### Solution to Problem

In order to attain the above-described object, the inventors have conducted a comprehensive research of an additive which does not have side effects and preventing decomposition of charge transporting compound in formation of a crosslinked protective layer without inhibiting radical chain polymerization and preventing the occurrence of charge trapping (a cause of reducing charge transportability) caused by the decomposition. As a result of this, the present inventors found that it is effective to incorporate a specific oxazole compound into a protective layer, and the finding leads to accomplishment of the present invention.

The present invention is based on the aforementioned finding made by the inventors, and means for resolving the above-described problems are described as follows:

<1> An electrophotographic photoconductor including:

a conductive support,

a charge generating layer,

a hole transporting layer, and

a hole transporting-protective layer,

the charge generating layer, the hole transporting layer and the hole transporting-protective layer being laminated in this order on the conductive support,

wherein the hole transporting-protective layer contains a three-dimensionally crosslinked product which is obtained through chain polymerization of at least a radical polymerizable hole-transporting compound by irradiating the radical polymerizable hole-transporting compound with an active energy beam, and

wherein the hole transporting-protective layer contains an oxazole compound represented by General Formula (1) or (2) below:

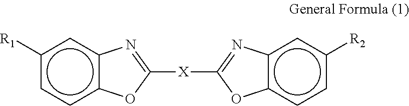

where R₁ and R₂ each represent a hydrogen atom or an alkyl group having 1 to 4 carbon atoms and may be identical to or different from each other; X represents a vinylene group, a divalent group of an aromatic hydrocarbon having 6 to 14 carbon atoms or a 2,5-thiophendiyl group,

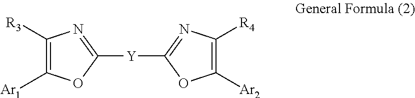

where Ar₁ and Ar₂ each represent a univalent group of an aromatic hydrocarbon having 6 to 14 carbon atoms, and may be identical to or different from each other; Y represents a divalent group of an aromatic hydrocarbon having 6 to 14 carbon atoms; and R₃ and R₄ each represent a hydrogen atom or a methyl group and may be identical to or different from each other.

<2> The electrophotographic photoconductor according to <1>, wherein an amount of the oxazole compound contained in the hole transporting-protective layer is 0.5% by mass to 10% by mass relative to an amount of the radical polymerizable-hole transporting compound.

<3> The electrophotographic photoconductor according to one of <1> and <2>, wherein a radical polymerizable reaction group contained in the radical polymerizable hole-transporting compound is an acryloyloxy group.

<4> An image forming method including:

repeatedly performing at least charging, image exposing, developing and image transferring, using the electrophotographic photoconductor according to any one of <1> to <3>.

<5> An image forming apparatus including:

the electrophotographic photoconductor according to any one of <1> to <3>.

<6> A process cartridge for image forming apparatus, the process cartridge including:

the electrophotographic photoconductor according to any one of <1> to <3>, and

at least one selected from a charging unit, a developing unit, a transfer unit, a cleaning unit, and a charge eliminating unit,

wherein the process cartridge is detachably mounted on a main body of an image forming apparatus.

### Advantageous Effects of Invention

It is possible to provide a photoconductor in which a three-dimensionally crosslinked protective layer by irradiating a radical polymerizable charge-transporting compound and a radical polymerizable monomer, on a conventional multi-layered photoconductor, with an active energy beam such as ultraviolet ray and electron beam (that is, a photoconductor in which at least a charge-generating layer, a hole-transporting layer, a hole-transporting protective layer which is three-dimensionally crosslinked through radical polymerization are laminated in this order on a conductive support), and which enables suppressing decomposition of the charge transporting compound caused during formation of a crosslinked film without degrading the electric properties and mechanical properties thereof and reducing charge trapping in the protective layer and is more excellent in charge transportability than conventional photoconductors, by adding a specific oxazole compound to the protective layer.

By reducing a change in potential during printing with time and a change in potential displacement in a surface of a printed matter through an improvement of the charge transportability of the protective layer, it is possible to output a high quality image having less change in image density and less in-plane nonuniformity of image density of a printed matter during printing with time.

Thus, the present invention can solve the various conventional problems, achieve the above-mentioned object, and provide an electrophotographic photoconductor which enables high-quality image outputting with a long life span and excellent cost performance, which is strongly requested in the commercial printing field, an image forming method, an image forming apparatus and a process cartridge for image forming apparatus, each using the electrophotographic photoconductor.

### BRIEF DESCRIPTION OF DRAWINGS

FIG. 1 is a cross-sectional diagram of one example of an electrophotographic photoconductor according to the present invention.

FIG. 2 is a schematic diagram illustrating one example of an image forming apparatus according to the present invention.

FIG. 3 is a schematic diagram illustrating one example of a process cartridge for image forming apparatus according to the present invention.

FIGS. 4A to 4C are schematic diagrams illustrating a measurement method of an elastic displacement rate by a microscopic surface hardness meter, where in FIG. 4C, the obliquely upward arrows indicate the directions of elastic force.

FIG. 5 is a diagram illustrating a relationship between a plastic displacement against a load applied and an elastic displacement rate.

FIG. 6 is an X-ray diffraction spectrum of a titanyl phthalocyanine crystal used in Examples.

### DESCRIPTION OF EMBODIMENTS

### Electrophotographic Photoconductor

An electrophotographic photoconductor according to the present invention includes a conductive support, and at least a charge generating layer, a hole transporting layer and a hole transporting protective layer which are laminated in this order on the conductive support, and further includes other layers as required.

The hole transporting-protective layer should include a three-dimensionally crosslinked product which is obtained through chain polymerization of at least a radical polymerizable hole-transporting compound by irradiating the radical polymerizable hole-transporting compound with an active energy beam, and further contains an oxazole compound represented by General Formula (1) or (2) below:

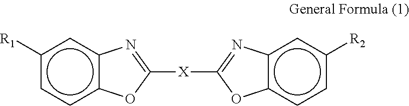

In General Formula (1), R₁ and R₂ each represent a hydrogen atom or an alkyl group having 1 to 4 carbon atoms and may be identical to or different from each other; X represents a vinylene group, a divalent group of an aromatic hydrocarbon having 6 to 14 carbon atoms or a 2,5-thiophendiyl group,

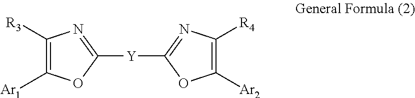

In General Formula (2), Ar₁ and Ar₂ each represent a univalent group of an aromatic hydrocarbon having 6 to 14 carbon atoms, and may be identical to or different from each other; Y represents a divalent group of an aromatic hydrocarbon having 6 to 14 carbon atoms; and R₃ and R₄ each represent a hydrogen atom or a methyl group and may be identical to or different from each other.

The present invention relates to a photoconductor having a hole transporting protective layer containing a three-dimensionally crosslinked product which is obtained by irradiating mainly a radical polymerizable hole-transporting compound or a mixture of the radical polymerizable hole-transporting compound with a polyfunctional radical polymerizable monomer with an active energy beam to initiate radical chain polymerization. The electrophotographic photoconductor enables suppressing charge trapping generated in the hole transporting protective layer and nonuniformity of the generation, preventing the occurrence of a change in potential displacement and variations in potential due to optical attenuation at each portion in a surface of the photoconductor, caused by the charge trapping, and high-quality image formation without substantially causing a change in image density and in-plane nonuniformity of image density during a continuous printing operation, which are required in the commercial printing field, by incorporating a specific oxazole compound into the hole transporting protective layer at the time of forming the hole transporting protective layer containing a three-dimensionally crosslinked product.

When the same optical writing is performed on a photoconductor capable of forming a high quality image, which is required in commercial printing, in-plane uniformity of potential so that the photoconductor has the same potential at any locations therein, and potential retention properties among printed paper sheets so that the photoconductor has the same charging potential and the same exposing potential during printing a number of paper sheets are required, and not only the film thickness and the homogeneity of a crosslinked hole transporting protective layer but also suppressing charge trapping inside of the hole transporting protective layer and the nonuniformity of the layer are necessary.

Even when a uniform coating film is formed by preventing elution of materials constituting the underlying layer etc. to the crosslinked hole transporting protective layer, nonuniformity of irradiation occurs depending on conditions for the production equipment used at the irradiation of an active energy beam for initiating a crosslinking reaction of the hole transporting protective layer. For example, when the hole transporting compound or the mixture with the polyfunctional radical polymerizable monomer is irradiated with an ultraviolet ray using a photopolymerization initiator, nonuniformity of ultraviolet ray irradiation to a surface of the resulting photoconductor is caused by reflection of light in a boundary area of the lamp used in the ultraviolet ray irradiating device and from inside of the ultraviolet ray irradiating device, and this influences on the film thickness and the homogeneity of the crosslinked film. Since nonuniformity of light irradiation was anticipated to lead to nonuniformity of crosslink density of the crosslinked hole transporting protective layer, an attempt was made to avoid nonuniformity of crosslink density by increasing the quantity of light so that the crosslinking of the film formed is brought closer to complete crosslinking, however, it was impossible to obtain an apparent effect, and rather, the increased quantity of light caused degradation in photosensitivity of the photoconductor. Therefore, it was presumed that the nonuniformity of light irradiation led to the nonuniformity of amount of photodecomposition products of the radical polymerizable charge transporting compound having a roll of the charge transportability in the hole transporting protective layer, not rather leading to the nonuniformity of crosslink density. For this reason, it was considered that if the photodecomposition could be reduced, it would be possible to suppress the generation of charge trapping in the hole transporting protective layer and the nonuniformity of the protective layer which could cause degradation in potential uniformity and potential maintainability.

Then, extensive examinations were carried out to find an additive not impairing a curing polymerization reaction at the time of irradiating an active energy beam such as ultraviolet ray, and the present inventors found out that an addition of a specific oxazole derivative to the hole transporting protective layer coating liquid is effective. The mechanism is not clearly known in detail, but is presumed that the radical polymerizable hole-transporting compound which is in an excited state by the active energy beam and the specific oxazole derivative form an intermolecular exciton-associated body (exciplex), and is devitalized from the excited state, and thereby a decomposition reaction of the radical polymerizable charge transporting compound from the excited state can be prevented.

Further, it is presumed that it is possible to suppress photodecomposition of the radical polymerizable hole-transporting compound during irradiation with an active energy beam such as irradiation with ultraviolet ray and prevent the occurrence of charge trapping in the hole transporting protective layer without impairing basic electric properties and mechanical properties as a photoconductor because of the material of the oxazole derivative which satisfies all the following conditions: in comparison with the oxidation potential of the radical polymerizable hole-transporting compound, the oxidation potential of the oxazole derivative is large, and thus hole trapping does not occur even in the hole transporting protective layer and the hole transportability does not degrade; most of oxazole derivatives have a short light absorption wavelength, and in the case of curing with ultraviolet ray, it has small absorption of a wavelength range necessary for initiation of polymerization and does not impair the crosslinking reaction; and the oxazole derivative has a lower excitation potential level than the radical polymerizable hole-transporting compound and easily forms an exciplex.

It can be considered that owing to the reduced generation of charge trapping in the hole transporting protective layer, the influence is reduced even when there is nonuniformity of ultraviolet ray irradiation etc. in the surface thereof, and thereby the in-plane uniformity of potential of the photoconductor and the potential stability with time is improved.

By using such an electrophotographic photoconductor, it is possible to output a high quality image excellent in uniformity of image density.

Hereinbelow, the electrophotographic photoconductor of the present invention will be described along with the layer structure.

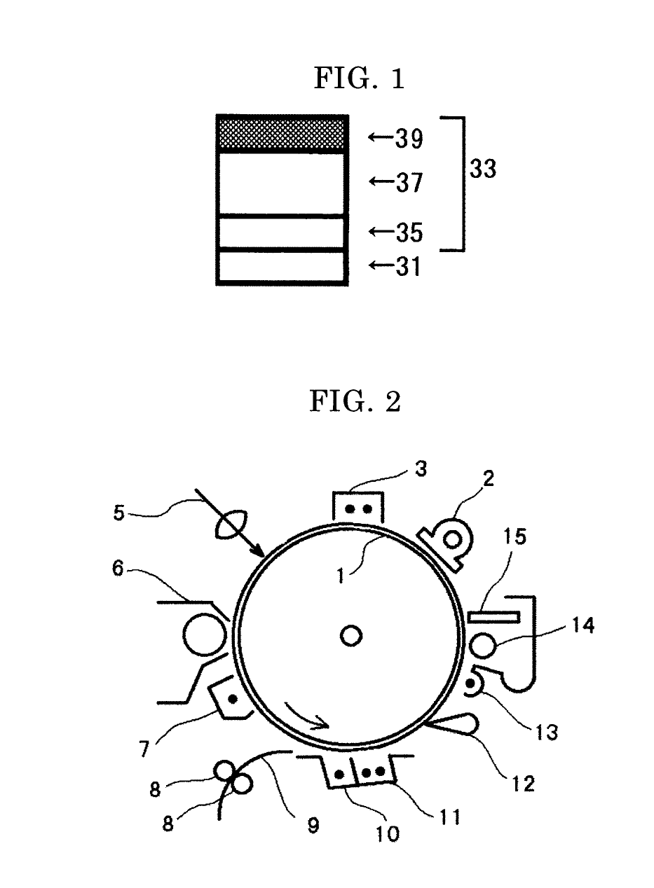

FIG. 1 is a cross-sectional diagram of one example of an electrophotographic photoconductor according to the present invention, which has a layer structure in which, on a conductive support 31, a charge generating layer 35 having a charge transportability, a hole transporting layer 37, and further, a hole transporting protective layer 39 are laminated in this order. These four layers are essential to constitute the electrophotographic photoconductor. Further, one layer or a plurality of layers of undercoat layers may be inserted between the conductive support 31 and the charge generating layer 35. A layer structural part constituted by the charge generating layer 35, the hole transporting layer 37 and the hole transporting protective layer 39 is called a photosensitive layer 33.

### <Conductive Support>

The conductive support is not particularly limited and may be suitably selected from among conventionally known conductive supports in accordance with the intended use. Examples thereof include those exhibiting conductivity of 10¹⁰Ω·cm or lower such as aluminum, and nickel. An aluminum drum, an aluminum-deposited film, a nickel belt and the like are preferably used.

Among these, since the dimensional accuracy of photoconductors are strictly required for obtaining high-image quality in the commercial printing field, a conductive support which is obtained according to the following method is preferable, in which an aluminum drum produced by a drawing process etc. is subjecting cutting and grinding/polishing processing to improve the surface smoothness and the dimensional accuracy. In addition, as the nickel belt, an endless nickel belt disclosed in Japanese Patent Application Laid-Open (JP-A) No. 52-36016 can be used.

### <Charge Generating Layer>

The charge generating layer is not particularly limited and may be suitably selected from among charge generating layers which have been used for conventionally used organic electrophotographic photoconductors, in accordance with the intended use. That is, a layer primarily containing a charge generating component having a charge transportability, and when necessary, a binder resin may also be used in combination. As a preferred charge generating material, for example, phthalocyanine-based pigments such as metal phthalocyanine, and metal-free phthalocyanine; and azo pigments are used. As the metal phthalocyanine, titanyl phthalocyanine, chlorogallium phthalocyanine, hydroxygallium phthalocyanine etc. are used. These charge generating materials may be used alone or in combination.

The binder resin is not particularly limited and may be suitably selected in accordance with the intended use. Examples thereof include polyamide, polyurethane, an epoxy resin, polyketone, polycarbonate, a silicone resin, an acrylic resin, polyvinyl butyral, polyvinyl formal, polyvinyl ketone, polystyrene, poly-N-vinylcarbazole, and polyacrylamide. These binder resins may be used alone or in combination.

The charge generating layer can be formed, for example, by dispersing the above-mentioned charge generating material, when necessary, along with a binder resin, in a solvent such as tetrahydrofuran, dioxane, dioxolan, toluene, dichloromethane, monochlorobenzene, dichloroethane, cyclohexanone, cyclopentanone, anisole, xylene, methylethylketone, acetone, ethyl acetate and butyl acetate, by means of a ball mill, an atrighter, a sand mill, a bead mill or the like, appropriately diluting the dispersion liquid, and applying the dispersion liquid onto the conductive support. In addition, when necessary, a leveling agent such as dimethylsilicone oil, methylphenyl silicone oil can be added to the dispersion liquid. The application of the dispersion liquid can be carried out by a dip coating method, a spray coating method, a bead coating method, a ring coating method or the like. The film thickness of the charge generating layer produced as above is preferably about 0.01 μm to about 5 μm, and more preferably 0.05 μm to 2 μm.

### <Hole-Transporting Layer>

The hole transporting layer is not particularly limited and may be suitably selected, in accordance with the intended use, from known charge transporting layer in which a hole transporting material is dispersed in a binder resin.

The hole transporting material is not particularly limited and may be suitably selected from known materials. Examples thereof include oxazole derivatives, imidazole derivatives, monoarylamine derivatives, diarylamino derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, and enamine derivatives. These derivatives may be used alone or in combination.

The binder resin is not particularly limited and may be suitably selected in accordance with the intended use. Examples thereof include thermoplastic or thermosetting resins such as polystyrene, styrene-acrylonitrile copolymers, styrene-butadiene copolymers, styrene-maleic anhydride copolymers, polyester, polyvinyl chloride, vinyl chloride-vinyl acetate copolymers, polyvinyl acetate, polyvinylidene chloride, polyarylate resins, phenoxy resins, polycarbonate, cellulose acetate resins, ethyl cellulose resins, polyvinyl butyral, polyvinyl formal, polyvinyl toluene, poly-N-vinylcarbazole, acrylic resins, silicone resins, epoxy resins, melamine resins, urethane resins, phenol resins, and alkyd resins. The amount of the charge transporting resin is preferably 20 parts by mass to 300 parts by mass, and more preferably 40 parts by mass to 150 parts by mass, relative to 100 parts by mass of the binder resin. As a solvent for use in coating of the hole transporting layer, a similar solvent to that used for the charge generating layer can be used, however, those capable of dissolving well the charge transporting material and the binder resin are suitable. These solvents may be used alone or in combination. The hole transporting layer can be formed by a similar coating method to that used for the charge generating layer.

To the hole transporting layer, a plasticizer and a leveling agent can also be added as required.

The plasticizer is not particularly limited and may be suitably selected in accordance with the intended use. For example, there may be exemplified those generally used as plasticizers for resins, such as dibutyl phthalate, and dioctyl phthalate. The amount of use thereof is preferably about 0 parts by mass to about 30 parts by mass relative to 100 parts by mass of the binder resin.

The leveling agent is not particularly limited and may be suitably selected in accordance with the intended use. Examples thereof include silicone oils such as dimethyl silicone oil, and methylphenyl silicone oil; and polymers or oligomers each having a perfluoroalkyl group in the side chain. The amount of use thereof is preferably about 0 parts by mass to about 1 part by mass relative to 100 parts by mass of the binder resin.

The film thickness of the hole transporting layer is preferably about 5 μm to about 40 μm, and more preferably about 10 μm to about 30 μm. On the thus formed hole transporting layer, a hole-transporting protective layer is formed.

### <Hole-Transporting Protective Layer>

The present invention is characterized in that the hole-transporting protective layer includes at least a three-dimensionally crosslinked product which can be obtained by radical chain polymerization of a radical polymerizable hole-transporting compound with a high-energy beam, and the crosslinked film contains a specific oxazole compound.

The specific oxazole compound, which is an essential material for the present invention, is represented by General Formula (1) or (2) below.

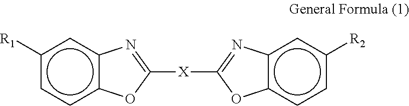

In General Formula (1), R₁ and R₂ each represent a hydrogen atom or an alkyl group having 1 to 4 carbon atoms and may be identical to or different from each other; and X represents a vinylene group, a divalent group of an aromatic hydrocarbon having 6 to 14 carbon atoms or a 2,5-thiophendiyl group.

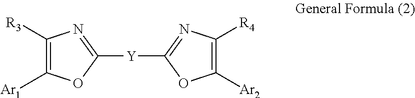

In General Formula (2), Ar₁ and Ar₂ each represent a univalent group of an aromatic hydrocarbon having 6 to 14 carbon atoms, and may be identical to or different from each other; Y represents a divalent group of an aromatic hydrocarbon having 6 to 14 carbon atoms; and R₃ and R₄ each represent a hydrogen atom or a methyl group and may be identical to or different from each other.

Here, examples of the alkyl group having 1 to 4 carbon atoms, which is represented by R₁ or R₂, include a methyl group, an ethyl group, n-propyl group, iso-propyl group, n-butyl group, iso-butyl group, sec-butyl group, and tert-butyl group. Examples of the divalent group of an aromatic hydrocarbon having 6 to 14 carbon atoms, which is represented by X, include o-phenylene group, p-phenylene group, 1,4-naphthalenediyl group, 2,6-naphthalenediyl group, 9,10-anthracenediyl group, 1,4-anthracenediyl group, 4,4′-bisphenyldiyl group, and 4,4′-stilbenediyl group.

Examples of the univalent group of an aromatic hydrocarbon having 6 to 14 carbon atoms, which is represented by Ar₁ or Ar₂, include aromatic hydrocarbon groups such as a phenyl group, 4-methylphenyl group, 4-tert-butylphenyl group, naphthyl group, and biphenylyl group.

Examples of the divalent group of an aromatic hydrocarbon group having 6 to 14 carbon atoms, which is represented by Y include o-phenylene group, p-phenylene group, 1,4-naphthalenediyl group, 2,6-naphthalenediyl group, 9,10-anthracenediyl group, 1,4-anthracenediyl group, 4,4′-bisphenyldiyl group, and 4,4′-stilbenediyl group.

Specific examples of oxazole compounds each represented by General Formula (1) or (2) will be described below, however, the oxazole compound is not limited thereto.

TABLE 1
Oxazole Compound Example (1)

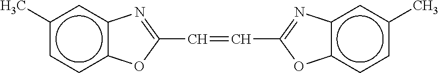

Oxazole Compound Example (2)

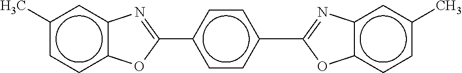

Oxazole Compound Example (3)

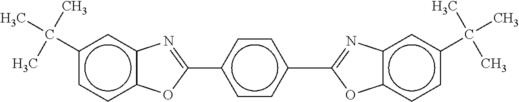

Oxazole Compound Example (4)

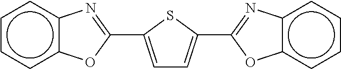

Oxazole Compound Example (5)

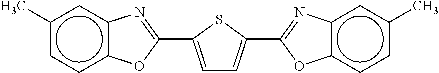

Oxazole Compound Example (6)

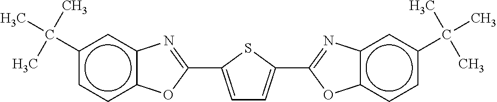

Oxazole Compound Example (7)

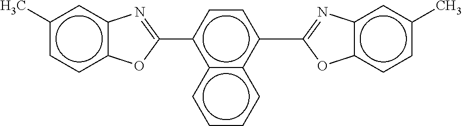

Oxazole Compound Example (8)

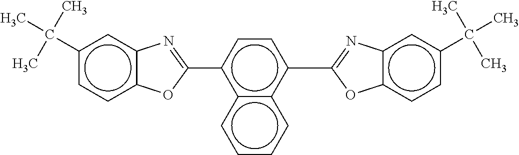

Oxazole Compound Example (9)

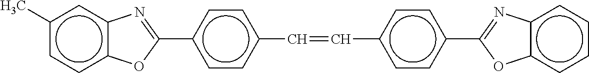

Oxazole Compound Example (10)

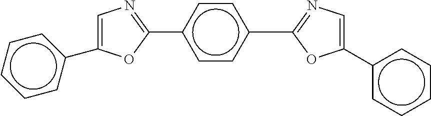

Oxazole Compound Example (11)

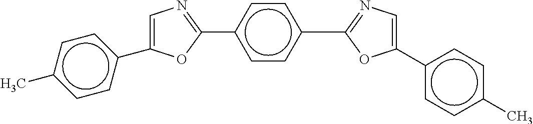

Oxazole Compound Example (12)

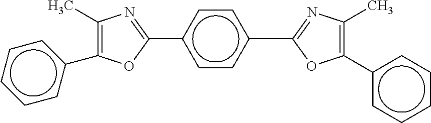

Oxazole Compound Example (13)

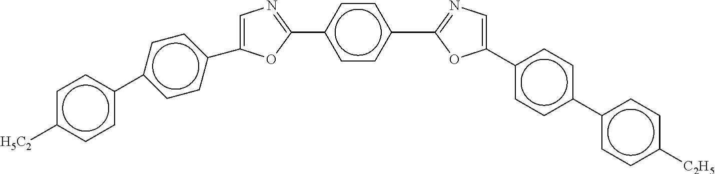

These oxazole compounds are added in an amount of 0.1% by mass to 30% by mass into the hole-transporting protective layer. When the addition amount is excessively small, the effect of reducing an in-plane potential variation is not observed, whereas the addition amount is excessively large, photosensitive properties of the resulting photoconductor degrade.

These oxazole compounds do not exhibit hole transportability as described above, and thus when an excessive amount of the oxazole compound is added to the hole-transporting protective layer, the hole transporting compound is diluted by the oxazole compound, which leads to degradation in charge transportability, causing degradation in photosensitivity. In addition, since an excessive addition of the oxazole compound also decrease the crosslink density brought by radical polymerization, it weakens the mechanical strength of the hole-transporting protective layer, leading to degradation of abrasion resistance of the resulting photoconductor. Therefore, it is desired to add the oxazole compound to the hole-transporting protective layer in an amount as smallest possible within an effective range. In experiments in which the addition amount of the oxazole compound was changed, the effect of suppressing the occurrence of charge trapping was clearly observed by adding the oxazole compound within a range of from 0.5% by mass to 10% by mass relative to the radical polymerizable hole-transporting compound in the hole-transporting protective layer, and it is more preferable in that side effects to the hole transporting protective layer are small.

Next, a method of forming the hole-transporting protective layer and the compounds other than the oxazole compound will be described below.

The hole-transporting protective layer of the present invention is three-dimensionally crosslinked by polymerizing mainly a radical polymerizable hole-transporting compound, and to make the radical polymerizable hole-transporting compound three-dimensionally crosslinked, there are the following conditions:

(1) When the number of radical polymerizable functional groups of the radical polymerizable hole-transporting compound is one, the radical polymerizable hole-transporting compound is mixed with a polyfunctional radical polymerizable monomer having 2 or more radical polymerizable functional groups in one molecule and then polymerized.
(2) When the number of radical polymerizable functional groups of the radical polymerizable hole-transporting compound is 2 or more, the radical polymerizable hole-transporting compound can be singularly polymerized, or is mixed with a polyfunctional radical polymerizable monomer having one or more radical polymerizable functional groups in one molecule and then polymerized.

A three-dimensionally crosslinked product (film) can be formed by radical chain polymerization of the radical polymerizable hole-transporting compound under the conditions described above. Even if a compound having only one radical polymerizable functional group is subjected to a radical polymerization reaction, it is only formed into a linear polymer, and even if the compound is made insoluble by entanglement of molecule chains, the crosslinked film of the present invention which is excellent in abrasion resistance cannot be obtained, and thus such a compound is inappropriate.

In addition, in (1) described above, it is more preferable that the radical polymerizable hole-transporting compound be mixed with a polyfunctional radical polymerizable monomer having 3 or more radical polymerizable functional groups in one molecule and then polymerized. This is because it is necessary to increase the compositional ratio of the radical polymerizable hole-transporting compound to improve the hole transportability of the hole transporting protective layer, and to form a film excellent in mechanical strength and having a high crosslink density with such a compositional ratio, it is advantageous that the number of functional groups of the polyfunctional radical polymerizable monomer to be mixed with the radical polymerizable hole-transporting compound is large.

Further, in formation of the hole transporting protective layer in the present invention, the radical polymerizable hole-transporting compound is irradiated with an active energy beam such as ultraviolet ray or an electron beam to initiate polymerization, and thereby a crosslinked film is formed. This is because a film which is harder and has a higher crosslink density and a higher elasticity power can be formed as compared to the case where the radical polymerizable hole-transporting compound is subjected to a polymerization reaction through heating using a thermal polymerization initiator or the like, and is a necessary condition for ensuring the abrasion resistance of the hole transporting protective layer of the present invention. Hence, because of the higher irradiation energy as compared to heat, excitation of the hole transporting structure is caused. From this state, part of this structure is decomposed to cause nonuniformity of light irradiation. The nonuniformity of light irradiation leads to nonuniformity of amount of photodecomposition products of the radical polymerizable hole transporting compound having a roll of the charge transportability in the hole transporting protective layer; charge trapping by the decomposed matter leads to potential nonuniformity inside surfaces of photoconductors; and the potential nonuniformity leads to in-plane nonuniformity of image density, which is a problem to be solved by the present invention.

Generally, to prevent a decomposition of the material due to such an irradiation with an active energy beam, the oxygen concentration is reduced in the presence of nitrogen gas, and to prevent an increase in temperature of the material during irradiation, the material is cooled. In the present invention, it is also possible to crosslink the radical polymerizable hole-transporting compound under such a condition.

In addition, in conventional examinations, it has been known that as a radical polymerizable hole-transporting compound, a compound having one functional group is used, a trifunctional or higher polyfunctional radical polymerizable monomer is mixed with the compound, a photopolymerization initiator is added to the mixture, the mixture is irradiated with ultraviolet ray to initiate a radical polymerization reaction and to be cured and to form a three-dimensionally crosslinked film, and such a reaction system is capable of forming a hole transporting protective layer excellent in hole transportability as well as in abrasion resistance. In the present invention, it is also possible to use such a reaction system as the most preferable reaction system.

That is, a monofunctional radical polymerizable hole-transporting compound, a trifunctional or higher polyfunctional radical polymerizable monomer, a photopolymerization initiator and the above-mentioned oxazole compound are dissolved in an appropriate solvent to prepare a mixture solution, the mixture solution is applied onto a hole transporting layer and then irradiated with ultraviolet ray to be crosslinking-reacted, and thereby a best suited hole transporting protective layer can be formed.

When, in this coating liquid, the radical polymerizable monomer is a liquid, the coating liquid can be applied onto the hole transporting layer after other components are dissolved in the coating liquid, however, as described above, the coating liquid is applied onto the hole transporting layer after the coating liquid is diluted with a solvent.

As a solvent used at this time, there may be exemplified alcohol-based solvents such as methanol, ethanol, propanol and butanol; ketone-based solvents such as acetone, methylethylketone, methyl isobutyl ketone, and cyclohexanone; ester-based solvents such as ethyl acetate, and butyl acetate; ether-based solvents such as tetrahydrofuran, dioxane, and propyl ether; halogen-based solvents such as dichloromethane, dichloroethane, trichloroethane, and chlorobenzene; aromatic solvents such as benzene, toluene, and xylene; and cellosolve-based solvents such as methyl cellosolve, ethyl cellosolve, and cellosolve acetate. These solvents may be used alone or in combination. The dilution rate with the solvent is changed depending on the solubility of the composition, the coating method and the intended film thickness, and can be arbitrarily selected. The application of the coating liquid can be carried out by a dip coating method, a spray coating method, a bead coating method, a rink coating method or the like.

For the irradiation with ultraviolet ray, UV irradiation light sources such as a high-pressure mercury vapor lamp and a metal halide lamp can be utilized.

The quantity of light irradiation is preferably 50 mW/cm² to 1,000 mW/cm². When the quantity of light irradiation is less than 50 mW/cm², it takes a long time for the curing reaction. When the quantity of light irradiation is more than 1,000 mW/cm², heat accumulation becomes intensified, an increase in temperature of the material cannot be suppressed even under a cooling condition, causing deformation of the resulting film, and it is impossible to prevent degradation of electric properties of the resulting photoconductor.

Here, as the radical polymerizable hole-transporting compound, the trifunctional or higher functional radical polymerizable monomer and photopolymerization initiator of the present invention, the charge transporting compound having a radical polymerizable functional group, the trifunctional or higher functional radical polymerizable monomer, the bifunctional or higher functional radical polymerizable monomer and the photopolymerization initiator described, for example, in Japanese Patent Application Laid-Open (JP-A) No. 2005-266513, and Japanese Patent Application Laid-Open (JP-A) No. 2004-302452, and Japanese Patent (JP-B) No. 4145820 can be used. The coating solvent, coating method, drying method, and conditions for ultraviolet ray-irradiation described in these patent documents can be used as they are, in the present invention.

That is, the radical polymerizable hole-transporting compound for use in the present invention means a compound having a hole transporting structure such as triarylamine, hydrazone, pyrazoline, and carbazole, and having a radical polymerizable functional group. As the radical polymerizable functional group, especially, an acryloyloxy group and a methacryloyloxy group are useful. The number of radical polymerizable functional groups per molecule of the radical polymerizable hole-transporting compound may be one or more, however, to easily obtain surface smoothness while suppressing the internal stress of the hole transporting protective layer and to maintain excellent electric properties, the number of radical polymerizable functional groups is preferably one. When the charge transporting compound has two or more radical polymerizable functional groups, the bulky hole transporting compound is fixed in crosslinked bonds via a plurality of bonds. Due to the above-mentioned reason, a large strain occurs, and the degree of margin may decrease, and concaves-convexes, cracks, and a film rupture may occur depending on the charge transporting structure and the number of functional groups. In addition, owing to the large strain, an intermediate structure (cation radical) during charge transportation cannot be stably maintained, and a decrease in photosensitivity caused by charge trapping and an increase in residual potential easily occur. As a hole transporting structure of the radical polymerizable transporting compound, a triarylamine structure is preferable for its high mobility.

The radical polymerizable hole-transporting compound for use in the present invention is important to impart hole transportability to the hole transporting protective layer. The amount of the radical polymerizable hole-transporting compound contained in the hole transporting protective layer coating liquid is adjusted so as to be 20% by mass to 80% by mass and more preferably 30% by mass to 70% by mass, relative to the total amount of the hole transporting protective layer. When the amount of this component is less than 20% by mass, the hole transportability of the hole transporting protective layer cannot be sufficiently maintained, and degradation in electric properties such as a decrease in photosensitivity and an increase in residual potential occur after repetitive use of the photoconductor. When the amount of the radical polymerizable hole-transporting compound is more than 80% by mass, the amount of the trifunctional or higher functional monomer having no hole transporting structure is reduced. This leads to a decrease in crosslinked bond density, and high abrasion resistance is not exhibited. The amount of the radical polymerizable hole-transporting compound cannot be unequivocally said because the electric properties and abrasion resistance required varies depending on the process used, however, in view of the balance between the electric properties and the abrasion resistance, a range of from 30% by mass to 70% by mass is most preferable.

The polyfunctional radical polymerizable monomer for use in the present invention means a monomer which does not have a hole transportable structure such as triarylamine, hydrazone, pyrazoline and carbazole and which has three or more radical polymerizable functional groups. This radical polymerizable functional group is not particularly limited, as long as it is a group having a carbon-carbon double bond and is radically polymerizable, and may be suitably selected in accordance with the intended use. Examples thereof include trimethylolpropane triacrylate (TMPTA), trimethylolpropane trimethacrylate, trimethylolpropane alkylene-modified triacrylate, trimethylolpropane ethyleneoxy-modified (hereinbelow, described as “EO-modified”)triacrylate, trimethylolpropane propyleneoxy-modified (hereinbelow, described as “PO-modified”)triacrylate, trimethylolpropane caprolactone-modified triacrylate, trimethylolpropane alkylene-modified trimethacrylate, pentaerithritol triacrylate, pentaerithritol tetraacrylate (PETTA), glycerol triacrylate, glycerol epichlorohydrin-modified (hereinbelow, described as “ECH-modified”)triacrylate, glycerol EO-modified triacrylate, glycerol PO-modified triacrylate, tris(acryloxyethyl)isocyanurate, dipentaerythritol hexaacrylate (DPHA), dipentaerythritol caprolactone-modified hexaacrylate, dipentaerythritol hydroxy pentaacrylate, alkylated dipentaerythritol pentaacrylate, alkylated dipentaerythritol tetraacrylate, alkylated dipentaerythritol triacrylate, dimethylolpropane tetraacrylate (DTMPTA), pentaerithritol ethoxy tetraacrylate, phosphoric acid EO-modified triacrylate, and 2,2,5,5,-tetrahydroxymethyl cyclopentanone tetraacrylate. These may be used alone or in combination.

The ratio of a molecular weight of the polyfunctional radical polymerizable monomer relative to the number of functional groups in the monomer (molecular weight/number of functional groups) is desirably 250 or smaller, for forming a dense crosslinked bond in the hole transporting protective layer. When the ratio is greater than 250, the hole transporting protective layer is soft, the abrasion resistance somewhat degrades, and thus, among the above-mentioned monomers, for the monomers having a modified group such as EO, PO, and caprolactone, it is unfavorable to singularly use an extremely long modified group. In addition, the amount of the trifunctional or higher functional radical polymerizable monomer having no charge transportability for use in the hole transporting protective layer in solid fractions of the coating liquid is adjusted so that the amount is 20% by mass to 80% by mass and preferably 30% by mass to 70% by mass, relative to the total amount of the hole transporting protective layer. When the amount of the monomer component is less than 20% by mass, the three-dimensional crosslink-bonding density of the hole transporting protective layer is small, and a remarkable increase in abrasion resistance is not attained as compared when a conventional thermoplastic binder resin is used. When the amount of the monomer component is more than 80% by mass, the amount of the charge transporting compound is reduced, and the electric properties degrade. The amount of the polyfunctional radical polymerizable monomer cannot be unequivocally said because the electric properties and abrasion resistance required varies depending on the process used, however, in view of the balance between the abrasion resistance and the electric properties, a range of from 30% by mass to 70% by mass is most preferable.

The photopolymerization initiator for use in the present invention is not particularly limited, as long as it is a polymerization initiator which easily generates radicals by an effect of light, and may be suitably selected in accordance with the intended use. Examples of the photopolymerization initiator include acetophenone-based or ketal-based photopolymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoin ether-based photopolymerization initiators such as benzoin, benzoin methyl ether, benzoin ethyl ether, and benzoin isopropyl ether; benzophenone-based polymerization initiators such as benzophenone, 4-hydroxybenzophenone, o-benzoyl methyl benzoate, 2-benzoylnaphthalene, 4-benzoylbiphenyl, 4-benzoylphenylether, acrylated benzophenone, and 1,4-benzoylbenzene; thioxanthone-based photopolymerization initiators such as 2-isopropylthioxanthone, 2-chlorothioxanthone, 2,4-dimethylthioxanthone, 2,4-diethylthioxanthone, and 2,4-dichlorothioxanthone; and photopolymerization initiators other than those described above such as ethyl anthraquinone, 2,4,6-trimethyl benzoyl diphenyl phosphine oxide, 2,4,6-trimethyl benzoyl phenyl ethoxy phosphine oxide, bis(2,4,6-trimethylbenzoyl)phenyl phosphine oxide, bis(2,4-dimethoxybenzoyl)-2,4,4-trimethylpentyl phosphineoxide, methylphenylglyoxy ester, 9,10-phenanthrene, an acridine-based compound, a triazine-based compound, and an imidazole-based compound. These polymerization initiators may be used alone or in combination. The amount of the polymerization initiator is preferably 0.5 parts by mass to 40 parts by mass, and more preferably 0.5 parts by mass to 10 parts by mass, relative to 100 parts by mass of the total amount of the components having radical polymerizability in the solid fractions of the coating liquid.

In the hole transporting protective layer of the present invention, monofunctional and bifunctional radical polymerizable monomers, and a radical polymerizable oligomer can be used in combination for the purpose of imparting functions of controlling the viscosity thereof at the time of coating, alleviating the stress of the hole transporting protective layer, reducing the surface energy, decreasing the abrasion coefficient and the like. As the radical polymerizable oligomer, conventionally known radical polymerizable oligomers can be utilized.

Further, the case where the number of functional groups of the radical polymerizable groups in the radical polymerizable hole-transporting compound is 2 or more will be described in detail. As described above, the radical polymerizable hole-transporting compound has, as a basic structure, a hole-trans patenting structure of an aromatic tertiary amine structure which has been conventionally known such as triarylamine, hydrazone, pyrazoline, and carbazole, and has 2 or more radical polymerizable groups in the molecule. For example, a large number of compound examples are described in Tables 3 to 86 in JP-A No. 2004-212959, and these compounds can be used in the present invention. Particularly, as the radical polymerizable group, the above-mentioned acryloyloxy group and methacryloyloxy group are preferable, and it is particularly preferable that these polymerizable groups are bonded to a hole transporting structure via an alkylene chain having 2 or more carbon atoms, more preferably an alkylene chain having 3 or more carbon atoms. With this, occurrence of the deformation described above as a defect of the bifunctional or higher polyfunctional radical polymerizable hole-transporting compound can be reduced.

Further, the hole transporting protective layer of the present invention may contain, additives other than the above-mentioned components and the after-mentioned additive components, such as a reinforcing agent (filler known as a heat-resistance improver), a dispersing agent, and a lubricant, within a range not impairing the effects of the present invention. For example, the reinforcing agent may be added to the hole transporting protective layer in an amount of 30 parts by mass, more preferably in an amount of 20 parts by mass or less, per 100 parts by mass of the resin materials containing a crosslinking material, as a range not impairing the electrical and optical properties of the photoconductor of the present invention.

Next, a method of forming a hole transporting protective layer through irradiation with an electron beam; i.e., a method of forming a crosslinked structure of the hole transporting protective layer will be described.

In the irradiation with an electron beam, there is no need to add a photopolymerization initiator to the coating liquid, and a radical polymerizable hole-transporting compound is singularly or a mixture of the radical polymerizable hole-transporting compound and a radical polymerizable monomer is dissolved in an appropriate solvent, and the resulting solution is applied onto a hole transporting layer, followed by irradiation, thereby a three-dimensionally crosslinked product (film) can be formed. The conditions for the crosslinking reaction are also described in JP-A No. 2004-212959, and a conventionally known technique can be used as it is. For example, the acceleration voltage of such an electron beam is preferably 250 kV or lower, and the irradiation quantity is preferably 1 Mrad to 20 Mrad, and the oxygen concentration during the irradiation is preferably 10,000 ppm or lower.

The active energy beam mentioned above encompasses, other than the ultraviolet ray and electron beams (accelerated electron beams), radioactive rays (e.g., α-ray, β-ray, γ-ray, X-ray, and accelerated ions), however, in an industrial use, ultraviolet rays and electron beams are mainly used.

### <Undercoat Layer>

In the photoconductor of the present invention, an undercoat layer may be provided between the conductive support and the photosensitive layer. Generally, the undercoat layer primarily contains resins, but taking into consideration that a photosensitive layer is applied onto these resins with a solvent, it is desirable that these resins have high resistance to typical organic solvents. Such resins are not particularly limited and may be suitably selected in accordance with the intended use. Examples thereof include water-soluble resins such as polyvinyl alcohol, casein, and sodium polyacrylate; alcohol-soluble resins such as nylon-based copolymers, and methoxy methylated nylon; polyurethane, melamine resins, phenol resins, alkyd-melamine resins, epoxy resins, and curable type resins forming a three-dimensional network structure.

In addition, for the purpose of preventing moiré and reducing residual potential, a fine-powder pigment of a metal oxide typified by a titanium oxide, silica, alumina, a zirconium oxide, a tin oxide, an indium oxide and the like may be added to the undercoat layer. These undercoat layers can be formed using an appropriate solvent and an appropriate coating method, as in the case of the photosensitive layer. Further, in the undercoat layers of the present invention, a silane coupling agent, a titanium coupling agent, a chromium coupling agent etc. may also be used. Besides, as the undercoat layers of the present invention, there may be favorably used an undercoat layer in which Al₂O₃ is formed by anodic oxidation, an under coat layer in which an organic substance such as polyparaxylylene (palylene) and an inorganic substance such as SiO₂, SnO₂, TiO₂, ITO, and CeO₂ is formed by a vacuum thin-film forming method. Besides, conventionally known undercoat layers may also be used. The film thickness of the undercoat layer is preferably 1 μm to 15 μm.

### <Addition of Antioxidant to Each Layer>

In the present invention, for the purpose of improving the environmental resistance, in particular, preventing degradation in photosensitivity and an increase in residual potential, an antioxidant may be added to individual layers of the hole transporting layer, the hole transporting protective layer, the charge generating layer, undercoat layers, etc. The antioxidant to be added to these layers is not particularly limited and may be suitably selected from conventionally known materials in accordance with the intended use. Examples thereof include a phenol-based compound, paraphenylenediamine, hydroquinone, an organic sulfur compound, and an organic phosphorus compound.

### (Phenol-Based Compound)

Examples of the phenol-based compound include 2,6-di-t-butyl-p-cresol, butylated hydroxy anisole, 2,6-di-t-butyl-4-ethylphenol, stearyl-β-(3,5-di-t-butyl-4-hdroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, and tocophenols.

### (Paraphenylenediamine)

Examples of the paraphenylenediamines include N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, and N,N′-dimethyl-N,N′-di-t-butyl-p-phenylenediamine.

### (Hydroquinone)

Examples of the hydroquinones include 2,5-di-t-octylhydroquinone, 2,6-didodecylhydroquinone, 2-dodecylhydroquinone, 2-dodecyl-5-chlorohydroquinone, 2-t-octyl-5-methylhydroquinone, and 2-(2-octadecenyl)-5-methylhydroquinone.

### (Organic Sulfur Compound)

Examples of the organic sulfur compound include dilauryl-3,3′-thiodipropionate, distearyl-3,3′-thiodipropionate, and ditetradecyl-3,3′-thiodipropionate.

### (Organic Phosphorous Compound)

Examples of the organic phosphorous compound include triphenylphosphine, tri(nonylphenyl)phosphine, tri(dinonylphenyl)phosphine, tricresylphosphine, and tri(2,4-dibutylphenoxy)phosphine.

These antioxidants are known as antioxidants used for oils and fats, and commercial products thereof are easily available.

The addition amount of the antioxidant in the present invention is 0.01% by mass to 10% by mass relative to the total mass of the layer to which the antioxidant is added.

### <Image Forming Method and Image Forming Apparatus>

Next, an image forming method and an image forming apparatus according to the present invention will be described in detail with reference to drawings.

The image forming method of the present invention is an image forming method which includes repeatedly performing at least charging, image exposure, developing and transferring, using the electrophotographic photoconductor of the present invention.

The image forming apparatus of the present invention is an image forming apparatus including the electrophotographic photoconductor of the present invention.

The image forming method of the present invention is an image forming method including a process of, for example, at least charging a surface of an electrophotographic photoconductor, image exposing, developing an image, transferring a toner image onto an image holding medium (transfer paper), fixing of image, and cleaning of the surface of the electrophotographic photoconductor, using a multi-layered type electrophotographic photoconductor which includes, on its surface, a crosslinked type charge transporting layer having extremely high abrasion resistance and scratch resistance and causing less cracks and film peeling. The image forming apparatus of the present invention is an image forming apparatus which undergoes the above-mentioned process. In some cases, in an image forming method where a latent electrostatic image is directly transferred to a transfer member and developed, the above-mentioned process provided for the electrophotographic photoconductor is not necessarily performed.

FIG. 2 is a schematic diagram illustrating one example of an image forming apparatus according to the present invention. As a charging unit for charging an electrophotographic photoconductor (which may be called “photoconductor”, hereinbelow), a charger 3 is used. As this charging unit, a corotron device, a scorotron device, a solid electric-discharge element, a needle electrode device, a roller charging device, a conductive brush device or the like is used, and a conventionally known charging method can be used. The configuration of the present invention is particularly effective when a charging unit from which proximate electric discharging causing decomposition of a composition of a photoconductor is generated, as is the case for a contact charging method or a non-contact-proximate charging method. The contact charging method mentioned herein is a charging method in which a charging roller, a charging brush, a charging blade and the like are directly contacted with a photoconductor. The proximate charging method is a charging method in which for example, a charging roller is disposed in the proximity of a photoconductor so that there is a gap of 200 μm or smaller between the photoconductor surface and the charging unit. When the gap is excessively large, charging tends to be unstable, whereas the gap is excessively small and if a residual toner is present on the surface of the photoconductor, there is a possibility that the surface of the charging member is contaminated with the residual toner. Therefore, the gap size is preferably 10 μm to 200 μm, and more preferably 10 μm to 100 μm.

Next, in order to form a latent electrostatic image on a photoconductor 1 which has been charged, an image exposing unit 5 is used. As a light source for the image exposing unit 5, overall light-emitting devices such as fluorescent lighting, a tungsten lamp, a halogen lamp, a mercury lamp, a sodium lamp, a light-emitting diode (LED), a semiconductor laser (LD), and an electroluminescence (EL) can be used. For irradiating an object with only light having a predetermined wavelength range, it is also possible to use various filters such as a sharp-cut filer, a band-pass filter, a near-infrared cut filter, a dichroic filter, an interference filter, a color conversion filter.

Next, in order to visualize the latent electrostatic image formed on the photoconductor 1, a developing unit 6 is used. As the developing method, there are one-component developing methods using a dry-process toner, two-component developing methods, and wet-process developing methods using a wet-process toner. When a photoconductor is negatively charged and an image thereon is exposed to light and in the case of reversal developing, a positively charged latent electrostatic image is formed on a surface of the photoconductor. When the positively charged latent electrostatic image is developed with a toner (electro-fine particles) having a negative polarity, a positive image can be obtained. When the positively charged latent electrostatic image is developed with a toner having a positive polarity, a negative image can be obtained.

In the case of normal developing, a negatively charged latent electrostatic image is formed on a surface of a photoconductor. When this image is developed with a toner (electro-fine particles) having a positive polarity, a positive image can be obtained, and when developed with a toner having a negative polarity, a negative image can be obtained.

Next, in order to transfer the toner image which has been visualized on the photoconductor onto a transferer 9, a transfer charger 10 is used. In addition, for more efficiently performing the transferring of the toner image, a pre-transfer charger 7 may be used. As these transfer units, an electrostatic transfer system using a transfer charger and a bias roller, a mechanical transfer system using an adhesion transfer, a pressure transfer method or the like, and a magnet transfer system can be utilized. As the electrostatic transfer system, the above-mentioned charging unit can be used.

Next, as a unit for separating the transferer 9 from the photoconductor 1, a separation charger 11 and a separation claw 12 are used. As separation units other than those described above, units employing electrostatic adsorption inductive separation, side edge belt separation, tip grip transfer, curvature separation and the like are used. As for the separation charger 11, a system similar to the charging unit is usable. Next, in order to clean (remove) a toner remained on the surface of the photoconductor after the transferring, a fur brush 14 and a cleaning blade 15 are used.

Further, in order to efficiently performing the cleaning, a pre-cleaning charger 13 may be used. As cleaning units other than those described above, there are a web system, a magnet system, etc. These systems may be singularly used or may be used altogether. Next, for the purpose of eliminating a latent image on the photoconductor as required, a charge eliminating unit is used. As the charge eliminating unit, a charge eliminating lamp 2 and a charge eliminating charger are used, and the exposure light source and the charging unit can be used, respectively. Besides, for processing of reading of an original document which is not provided in the proximity of the photoconductor, paper-feeding, fixing, ejection of paper etc., conventionally known units may be used. Note that in FIG. 2, reference numeral 8 denotes a registration roller.

### (Process Cartridge)

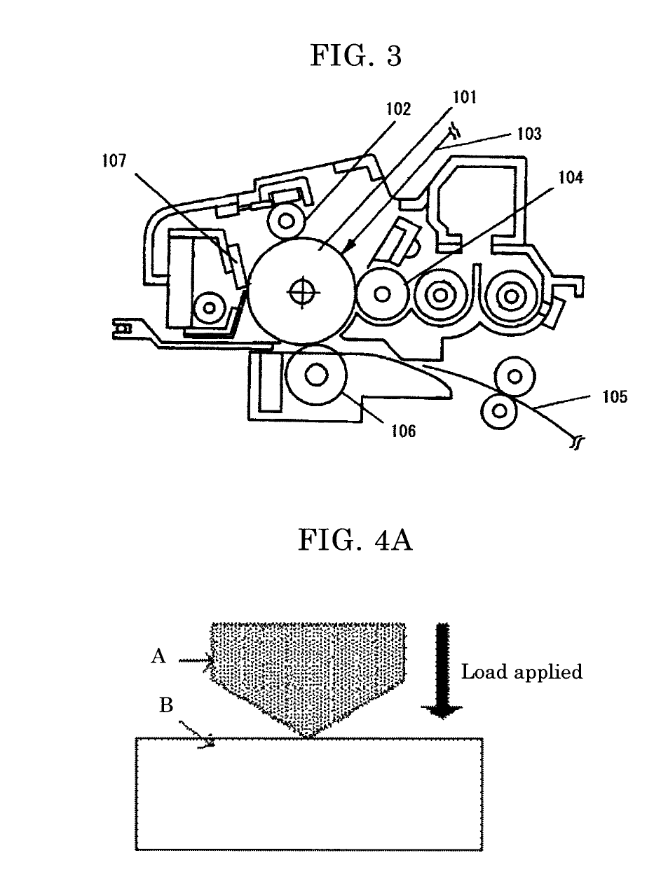

The present invention provides an image forming method and an image forming apparatus using an electrophotographic photoconductor of the present invention as such an image forming unit. This image forming unit may be incorporated in a fixed manner into a copier, a facsimile or a printer or may be detachably mounted thereto in the form of a process cartridge. FIG. 3 illustrates an example of the process cartridge of the present invention.

The process cartridge of the present invention includes the above-mentioned electrophotographic photoconductor of the present invention and at least one selected from a charging unit, a developing unit, a transfer unit, a cleaning unit and a charge-eliminating unit, wherein the process cartridge is detachably mounted on a main body of an image forming apparatus.

The process cartridge for image forming apparatus is a device (a component) equipped with a photoconductor 101 and including, other than the photoconductor 101, at least one selected from a charging unit 102, a developing unit 104, a transfer unit 106, a cleaning unit 107 and a charge eliminating unit (not illustrated), and detachably mounted on a main body of an image forming apparatus. An image forming process through use of a device illustrated in FIG. 3 will be described. The photoconductor 101 undergoes charging by the charging unit 102, and exposure to light by an exposing unit 103 while being rotated in the direction indicated by an arrow in the figure, and a latent electrostatic image corresponding to an exposed image is formed on its surface. The latent electrostatic image is developed, with a toner, by the developing unit 104, and the image developed with the toner is transferred onto a transferer 105 by the transfer unit 106 to be printed out. Next, the surface of the photoconductor after the transfer of the image is cleaned by the cleaning unit 107 and further charge-eliminated by the charge eliminating unit (not illustrated), and the above-mentioned operations are repeatedly performed.

The present invention provides a process cartridge for image forming apparatus, in which a laminated type photoconductor having, on its surface, a crosslinked charge transporting layer having high abrasion resistance and high scratch resistance and hardly causing film rupture, and at least one selected from a charging unit, a developing unit, a transfer unit, a cleaning unit and a charge eliminating unit are integrated into one unit.

As clear from the above description, the electrophotographic photoconductor of the present invention can be utilized not only in electrophotographic copiers, but also widely used in electrophotography application fields, such as laser printers, CRT printers, LED printers, liquid crystal printers and laser print reproduction.

The measurement methods according to the present invention will be described in detail.

### <Measurement of Elastic Displacement Rate of the Present Invention by Microscopic Surface Hardness Meter>

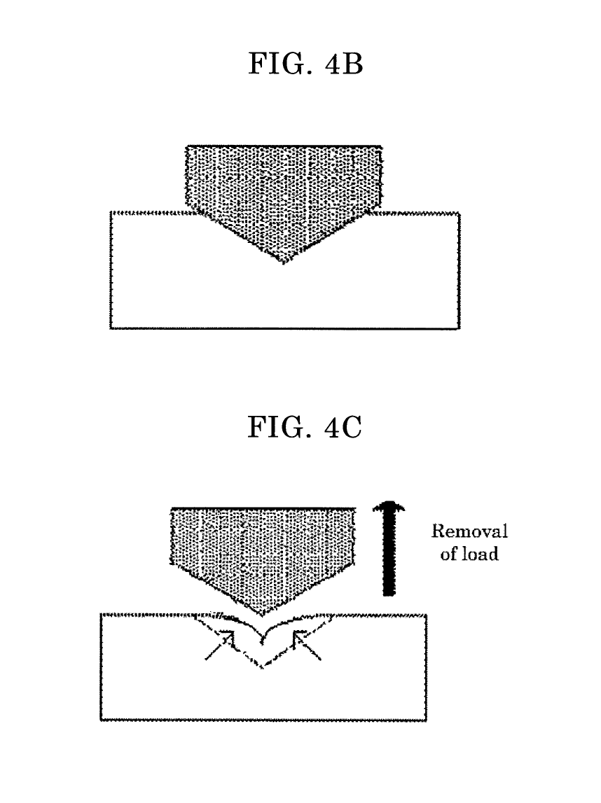

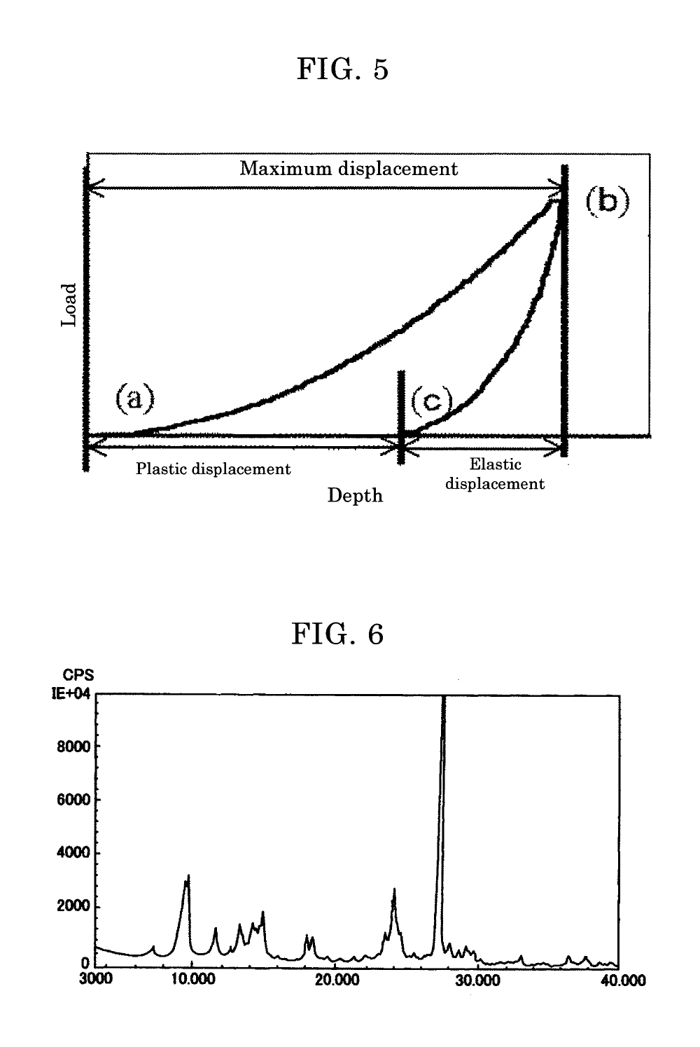

An elastic displacement rate τe of the present invention is measured by a load-unload test by a microscopic surface hardness meter using a diamond indenter. As illustrated in FIGS. 4A to 4C, the indenter A is pushed into a sample B from a point (a) (FIG. 4A) where the indenter A is contacted with the sample B at a constant load speed (loading process), the indenter A is left at rest for a certain length of time at a maximum displacement (maximum load, maximum deformation) (b) (FIG. 4B) when the load reaches a set load, and further, the indenter A is pulled up at a constant unload speed (unloading process), and a point at which finally, no load is applied to the indenter A is regarded as a plastic displacement (permanent set) (c) (FIG. 4C). A curve of a push-in depth in relation to a load applied, obtained at this time, is recorded as in FIG. 5, the maximum displacement (b), the plastic displacement (c) and the elastic displacement rate τe is calculated based on the following equation.

Elastic Displacement Rate τe (%)={[Maximum Displacement)−(Plastic Displacement)]/(Maximum Displacement)}×100

The measurement of the elastic displacement rate is performed at a constant temperature/humidity condition, and the elastic displacement rate in the present invention means a measurement value of the test performed under the environmental conditions of a temperature: 22° C., and a relative humidity: 55%.

In the present invention, a dynamic microscopic surface hardness meter DUH-201 (manufactured by Shimadzu Corporation), and a triangular indenter (115°) are used, however, the elastic displacement rate may be measured by any devices having abilities equal to those of these devices.

As for a standard deviation of the elastic displacement rate τe, first, each elastic displacement rate τe was measured at arbitrarily selected 10 portions on a sample, and the standard deviation was calculated based on the 10 measured values. In the measurement, a photoconductor having a hole transporting protective layer of the present invention was provided to an aluminum cylinder, and the photoconductor was appropriately cut and used. The elastic displacement rate τe receives influence of spring properties of the support, and thus a rigid metal plate, a slide glass and the like are suitable for the support. Further, elements of the hardness and the elasticity of underlying layer of the hole transporting protective layer (e.g., a charge transporting layer, and a charge generating layer) influence on the elastic displacement rate τe, a prescribed weight application was controlled so that the maximum displacement was 1/10 the film thickness of the hole transporting protective layer, in order to reduce these influences. When only the hole transporting protective layer is singularly prepared on a substrate, it is unfavorable because the components contained in the underlying layer are mixed in the hole transporting protective layer, the adhesion properties thereof with the underlying layer vary, and the hole transporting protective layer of the photoconductor cannot be precisely reproduced.

### EXAMPLES

Next, the present invention will be further described in detail with reference to Examples, however, the present invention is not limited to the following Examples. Note that the unit “part(s)” described in Examples means “part(s) by mass”.

### Example 1

Onto an aluminum cylinder having a diameter of 60 mm and a surface which had been ground and polished, an undercoat layer coating liquid, a charge generating layer coating liquid, and a hole transporting layer coating liquid each containing the following composition were applied, in this order, by a dipping method, and then dried, to thereby form an undercoat layer having a thickness of 3.5 μm, a charge generating layer having a thickness of 0.2 μm and hole transporting layer having a thickness of 22 μm. On the hole transporting layer, a hole transporting-protective layer coating liquid containing the following composition, in which 5% by mass of an oxazole compound had been added to a radical polymerizable hole-transporting compound, was sprayed so as to coat the hole transporting layer, and then naturally dried for 20 minutes. Subsequently, the aluminum cylinder was irradiated with light under the conditions: metal halide lamp: 160 W/cm, irradiation distance: 120 mm, irradiation intensity: 500 mW/cm², and irradiation time: 180 sec, so as to harden the coated film. Further, the surface of the cylinder was dried at 130° C. for 30 min to form a hole transporting-protective layer having a thickness of 4.0 μm, and thereby an electrophotographic photoconductor of the present invention was produced.

### [Undercoat Layer Coating Liquid]

| | |
|---|---|
| alkyd resin | 6 parts |
| (BECKOZOLE 1307-60-EL, produced by Dainippon Ink | |
| Chemical Industries Co., Ltd.) | |
| melamine resin | 4 parts |
| (SUPER BECKAMINE G-821-60, produced by Dainippon | |
| Ink Chemical Industries Co., Ltd.) | |
| titanium oxide | 50 parts |
| methylethylketone | 50 parts |

### [Charge Generating Layer Coating Liquid]

| | | |
|---|---|---|
| titanyl phthalocyanine crystal obtained | 15 | parts |
| by a synthesis described below | | |
| polyvinyl butyral (produced | 10 | parts |
| by Sekisui Chemical Co. Ltd.: BX-1) | | |
| 2-butanone | 280 | parts |

In a commercially available bead mill dispersing machine, in which a PSZ ball having a diameter of 0.5 mm was used, a 2-butanone solution in which polyvinyl butyral had been dissolved, and the titanyl phthalocyanine crystal were charged, and the components were dispersed for 30 minutes at a rotor revolution speed of 1,200 rpm to thereby prepare a charge generating layer coating liquid.

### (Synthesis of Titania Crystal)

The synthesis was complied with the synthesis method described in Japanese Patent Application Laid-Open (JP-A) No. 2004-83859. More specifically, 1,3-diiminoisoindlin (292 parts) and sulfolane (1,800 parts) were mixed, and titanium tetrabutoxide (204 parts) was added dropwise to the mixture under nitrogen air stream. After completion of the dropping, the temperature of the system was gradually increased to 180° C., and stirred for 5 hours for reaction, while the reaction temperature being maintained from 170° C. to 180° C. After completion of the reaction, the reaction system was naturally cooled, and filtered to separate out a precipitate, washed with chloroform until the powder turned into blue, washed with methanol several times, further washed with hot water of 80° C. several times, and then dried to thereby obtain coarse titanyl phthalocyanine. The coarse titanyl phthalocyanine was then dissolved in concentrated sulfuric acid an amount of which was 20 times the amount of the coarse titanyl phthalocyanine, and the resulting solution was added dropwise to iced water an amount of which was 100 times the amount of the coarse titanyl phthalocyanine. The resulting precipitated crystal was separated by filtration, and the separated crystal was repeatedly washed with ion-exchanged water (pH: 7.0, specific conductance: 1.0 μS/cm) until the washing liquid became neutral (pH of the ion-exchanged water after washing was 6.8, specific conductance was 2.6 μS/cm), to thereby obtain a wet cake (water paste) of a titanyl phthalocyanine pigment.

The obtained wet cake (water paste) (40 parts) was added to 200 parts of tetrahydrofuran. The resulting mixture was strongly stirred (2,000 rpm) at room temperature by means of a homomixer (MARKIIf model, manufactured by Kenis Limited), and the stirring operation was terminated when the color of the paste was changed from dark navy blue to light blue (after 20 minutes from the start of the stirring operation), and the resultant was subjected to vacuum filtration right after the termination of the stirring operation. The obtained crystal by the filtration device was washed with tetrahydrofuran, to thereby obtain a wet cake of a pigment. The obtained pigment was dried at 70° C. under reduced pressure (5 mmHg) for 2 days, to thereby obtain 8.5 parts of titanyl phthalocyanine crystal. The solid fraction of the wet cake was 15% by mass. The amount of the transformation solvent used was 33 parts by mass relative to 1 part by mass of the wet cake. Moreover, a halogen-containing compound was not used for starting materials of Synthesis Example 1. The obtained titanyl phthalocyanine powder was subjected to X-ray diffraction spectroscopy under the conditions listed below, and as a result, the spectrum of the titanyl phthalocyanine powder where Bragg angle 20 with respect to the CuKα ray (wavelength: 1.542 Å) had the maximum peak at 27.2°±0.2° and a peak at the smallest angle of 7.3°±0.2°, main peaks at 9.4°±0.2°, 9.6°±0.2°, and 24.0°±0.2°, and did not have any peak between the peak at 7.3° and the peak at 9.4°, and moreover did not have a peak at 26.3°, was obtained. The results are shown in FIG. 6.

### <Conditions for X-Ray Diffraction Spectrum Measurement>

X-ray bulb: Cu

Voltage: 50 kV

Current: 30 mA

Scanning speed: 2°/min

Scanning range: 3° to 40°

Time constant: 2 seconds

### [Hole Transporting Layer Coating Liquid]

| | | |
|---|---|---|
| Bisphenol Z polycarbonate resin | 10 | parts |
| (PANLITE TS-2050, produced by Teijin Chemicals Ltd.) | | |
| hole transporting material having a structure (HTM-1) described | 10 | parts |
| below | | |
| tetrahydrofuran | 100 | parts |
| tetrahydrofuran solution containing 1% silicone oil | 0.2 | parts |
| (KF50-100CS, produced by Shin-Etsu Chemical Co., Ltd.) | | |
| antioxidant BHT | 0.2 | parts |

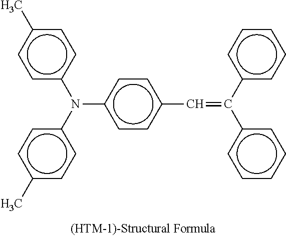

### [Hole Transporting-Protective Layer Coating Liquid]

| | | |
|---|---|---|
| polyfunctional radical polymerizable monomer | 10 | parts |
| trimethylolpropane triacrylate (KAYARAD TMPTA, produced | | |
| by Nippon Kayaku Co., Ltd.) molecular weight: 296; | | |
| the number of functional groups: trifunctional; | | |
| molecular weight/number of functional groups = 99 | | |
| radical polymerizable hole-transporting compound (RHTM-1) | 10 | parts |
| having the following Structural Formula | | |
| photopolymerization initiator | 1 | part |
| 1-hydroxy-cyclohexyl-phenyl-ketone (IRGACURE 184, | | |
| produced by Chiba Specialty Chemicals K.K.) | | |
| oxazole compound | 0.5 | parts |
| (a compound of Oxazole Compound Example (1) listed above) | | |
| tetrahydrofuran | 100 | parts |

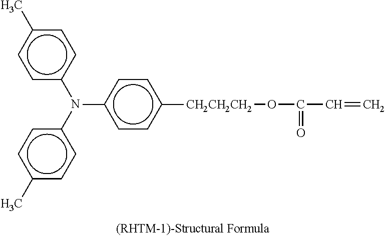

### Example 2

An electrophotographic photoconductor was prepared in the same manner as in Example 1, except that the hole transporting material (HTM-1) and the radical polymerizable hole-transporting compound (RHTM-1) were respectively changed to a hole transporting material (HTM-2) and a radical polymerizable hole-transporting compound (RHTM-2) each represented by the following Structural Formula, and Oxazole Compound Example (4) was used as the oxazole compound.

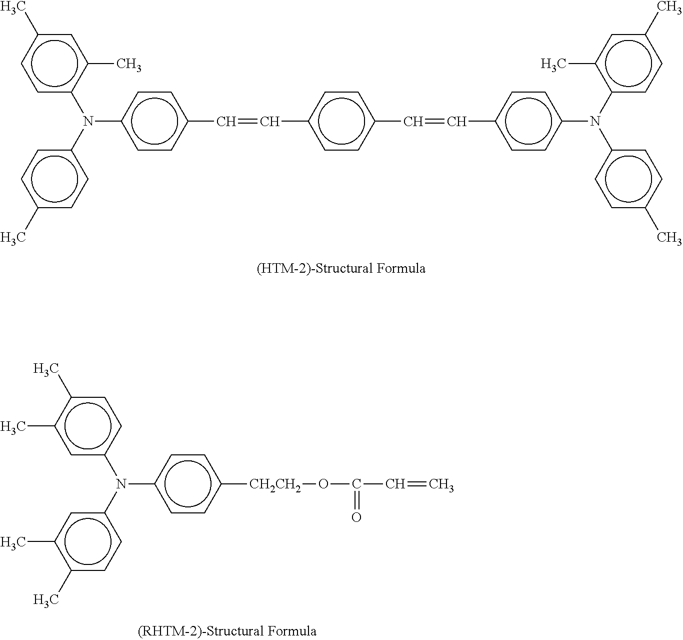

### Example 3

An electrophotographic photoconductor was prepared in the same manner as in Example 2, except that the radical polymerizable hole-transporting compound (RHTM-2) was changed to a radical polymerizable hole-transporting compound (RHTM-3) having the following Structural Formula, and Oxazole Compound Example (6) was used as the oxazole compound.

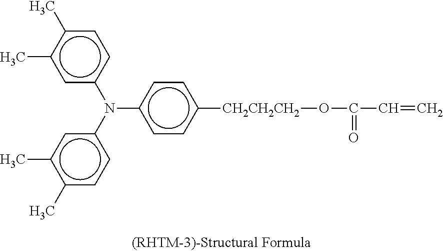

### Example 4

An electrophotographic photoconductor was prepared in the same manner as in Example 1, except that the composition of the hole transporting-protective layer coating liquid was changed to the following composition.

### [Hole Transporting-Protective Layer Coating Liquid]

| | | |
|---|---|---|
| polyfunctional radical polymerizable monomer (1) | 5 | parts |
| trimethylolpropane triacrylate (KAYARAD TMPTA, produced | | |
| by Nippon Kayaku Co., Ltd.) molecular weight: 296; | | |
| the number of functional groups: trifunctional; | | |
| molecular weight/number of functional groups = 99 | | |
| polyfunctional radical polymerizable monomer (2) | 5 | parts |
| caprolactone-modified dipentaerythritol hexaacrylate | | |
| (KAYARAD DPCA-120, produced by Nippon Kayaku Co., | | |
| Ltd.) molecular weight: 1,947; the number of functional | | |
| groups: hexafunctional; molecular weight/number of functional | | |
| groups =325 | | |
| hole transporting compound having the following structure | 10 | parts |
| (RHTM-4) | | |
| photopolymerization initiator | 1 | part |
| 1-hydroxy-cyclohexyl-phenyl-ketone (IRGACURE 184, | | |
| produced by Chiba Specialty Chemicals K.K.) | | |
| oxazole compound | 0.5 | parts |
| (a compound of Oxazole Compound Example (7) listed above) | | |
| tetrahydrofuran | 100 | parts |
| tetrahydrofuran solution containing 1% silicone oil | 0.2 | parts |
| (KF50-100CS, produced by Shin-Etsu Chemical Co., Ltd.) | | |

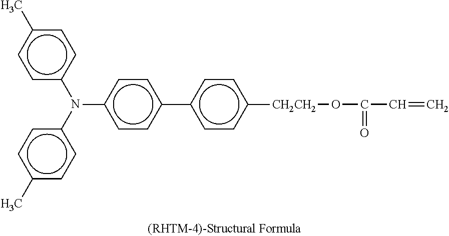

### Example 5

An electrophotographic photoconductor was prepared in the same manner as in Example 1, except that the composition of the hole transporting-protective layer coating liquid was changed as follows.

### [Hole Transporting-Protective Layer Coating Liquid]

| | | |
|---|---|---|
| polyfunctional radical polymerizable monomer | 10 | parts |
| pentaerythritol tetraacrylate (SR-295, Kayaku Sartmer Co., Ltd.) | | |
| molecular weight: 352; the number of functional groups: | | |
| tetrafunctional; molecular weight/number of functional groups = | | |
| 88 | | |
| radical polymerizable hole-transporting compound having the | 10 | parts |
| following structure (RHTM-5) | | |
| photopolymerization initiator | 1 | part |
| 1-hydroxy-cyclohexyl-phenyl-ketone (IRGACURE 184, | | |
| produced by Chiba Specialty Chemicals K.K.) | | |
| oxazole compound | 0.5 | parts |
| (a compound of Oxazole Compound Example (10) listed above) | | |
| tetrahydrofuran | 100 | parts |
| tetrahydrofuran solution containing 1% silicone oil | 0.2 | parts |
| (KF50-100CS, produced by Shin-Etsu Chemical Co., Ltd.) | | |

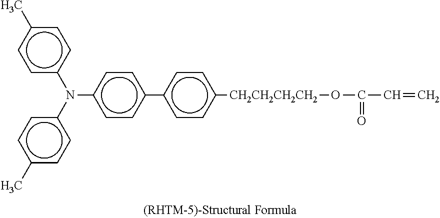

### Example 6

An electrophotographic photoconductor was prepared in the same manner as in Example 1, except that the composition of the hole transporting-protective layer coating liquid was changed as follows.

### [Hole Transporting-Protective Layer Coating Liquid]

| | | |
|---|---|---|
| polyfunctional radical polymerizable monomer (1) | 5 | parts |
| trimethylolpropane triacrylate (KAYARAD TMPTA, produced | | |
| by Nippon Kayaku Co., Ltd.) | | |
| molecular weight: 296; the number of functional groups: | | |
| trifunctional; molecular weight/number of functional groups = 99 | | |
| polyfunctional radical polymerizable monomer (2) | 5 | parts |
| caprolactone-modified dipentaerythritol hexaacrylate | | |
| (KAYARAD DPCA-60, produced by Nippon Kayaku Co., Ltd.) | | |
| molecular weight: 1,263; the number of functional groups: | | |
| hexafunctional; molecular weight/number of functional groups = | | |
| 211 | | |
| radical polymerizable hole-transporting compound having the | 10 | parts |
| following structure (RHTM-6) | | |
| photopolymerization initiator | 1 | part |
| 1-hydroxy-cyclohexyl-phenyl-ketone (IRGACURE 184, | | |
| produced by Chiba Specialty Chemicals K.K.) | | |
| oxazole compound | 0.5 | parts |
| (a compound of Oxazole Compound Example (12) listed above) | | |
| tetrahydrofuran | 100 | parts |
| tetrahydrofuran solution containing 1% silicone oil | 0.2 | parts |
| (KF50-100CS, produced by Shin-Etsu Chemical Co., Ltd.) | | |

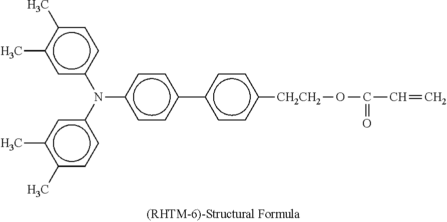

### Example 7

An electrophotographic photoconductor was prepared in the same manner as in Example 1, except that the composition of the hole transporting-protective layer coating liquid was changed as follows.

### [Hole Transporting-Protective Layer Coating Liquid]

| | | |
|---|---|---|
| polyfunctional radical polymerizable monomer | 4 | parts |
| trimethylolpropane triacrylate (KAYARAD TMPTA, produced by Nippon | | |
| Kayaku Co., Ltd.) | | |
| molecular weight: 296; the number of functional groups: trifunctional; | | |
| molecular weight/number of functional groups = 99 | | |
| radical polymerizable hole-transporting compound having the following | 6 | parts |
| structure (RHTM-7) | | |
| photopolymerization initiator | 1 | part |
| 1-hydroxy-cyclohexyl-phenyl-ketone (IRGACURE 184, produced by Chiba | | |
| Specialty Chemicals K.K.) | | |
| oxazole compound | 0.5 | parts |
| (a compound of Oxazole Compound Example (2) listed above) | | |
| tetrahydrofuran | 100 | parts |

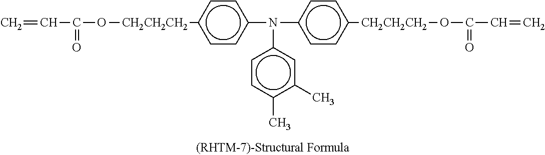

### Example 8

Onto an aluminum cylinder having a diameter of 60 mm and a surface which had been ground and polished, an undercoat layer coating liquid, a charge generating layer coating liquid, and a hole transporting layer coating liquid each containing the following composition were applied, in this order, by a dipping method, and then dried, to thereby form an undercoat layer having a thickness of 3.5 μm, a charge generating layer having a thickness of 0.2 μm and hole transporting layer having a thickness of 25 μm. On the hole transporting layer, a hole transporting-protective layer coating liquid containing the following composition, in which 5% by mass of an oxazole compound had been added to a radical polymerizable hole-transporting compound, was sprayed so as to coat the hole transporting layer, and then dried at 50° C. for 10 minutes. Subsequently, the aluminum cylinder was irradiated with light under the conditions: metal halide lamp: 120 W/cm, irradiation distance: 110 mm, irradiation intensity: 450 mW/cm², and irradiation time: 160 sec, so as to harden the coated film. Further, the surface of the cylinder was dried at 130° C. for 30 min to form a hole transporting-protective layer having a thickness of 5 μm, and thereby an electrophotographic photoconductor of the present invention was produced.

### [Undercoat Layer Coating Liquid]

| | | |
|---|---|---|
| alkyd resin (BECKOZOLE 1307-60-EL, produced by Dainippon Ink Chemical Industries | 6 | parts |
| Co., Ltd.) | | |
| melamine resin (SUPER BECKAMINE G-821-60, produced by Dainippon Ink Chemical | 4 | parts |
| Industries Co., Ltd.) | | |
| titanium oxide | 50 | parts |
| methylethylketone | 50 | parts |
| [Charge Generating Layer Coating Liquid] | | |
| bis-azo pigment having the following Structural Formula (CGM-1) | 2.5 | parts |
| polyvinyl butyral resin (XYHL, produced by UCC Corp.) | 0.5 | parts |
| cyclohexanone | 200 | parts |
| methylethylketone | 80 | parts |

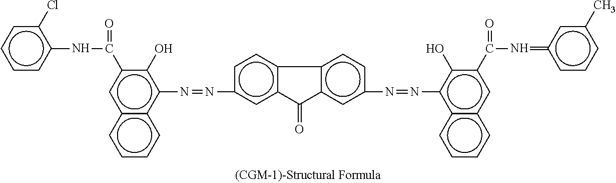

### [Hole Transporting Layer Coating Liquid]

| | |
|---|---|
| Bisphenol Z polycarbonate resin | 10 parts |
| (PANLITE TS-2050, produced by Teijin Chemicals Ltd.) | |
| hole transporting material having the structure (HTM-1) | 10 parts |
| described above | |
| tetrahydrofuran | 100 parts |
| tetrahydrofuran solution containing 1% silicone oil | 0.2 parts |
| (KF50-100CS, produced by Shin-Etsu Chemical Co., Ltd.) | |
| antioxidant BHT | 0.2 parts |

### [Hole Transporting-Protective Layer Coating Liquid]

| | |
|---|---|
| polyfunctional radical polymerizable monomer | 10 parts |
| trimethylolpropane triacrylate (KAYARAD TMPTA, | |
| produced by Nippon Kayaku Co., Ltd.) | |
| molecular weight: 296; the number of functional groups: | |
| trifunctional; molecular weight/number of functional | |
| groups = 99 | |
| radical polymerizable hole-transporting compound (RHTM-2) | 10 parts |
| having the Structural Formula described above | |
| oxazole compound (a compound of Oxazole Compound | 0.5 parts |
| Example (9) listed above) | |
| tetrahydrofuran | 100 parts |

### Example 9

An electrophotographic photoconductor was produced in the same manner as in Example 4, except that and a compound of Oxazole Compound Example (6) was used as the oxazole compound, and the addition amount thereof was changed to 0.3% by mass relative to the amount of the radical polymerizable hole-transporting compound.

### Example 10

An electrophotographic photoconductor was produced in the same manner as in Example 9, except that the addition amount of the oxazole compound (Oxazole Compound Example (6)) was changed to 0.5% by mass relative to the amount of the radical polymerizable hole-transporting compound.

### Example 11

An electrophotographic photoconductor was produced in the same manner as in Example 9, except that the addition amount of the oxazole compound (Oxazole Compound Example (6)) was changed to 1% by mass relative to the amount of the radical polymerizable hole-transporting compound.

### Example 12

An electrophotographic photoconductor was produced in the same manner as in Example 9, except that the addition amount of the oxazole compound (Oxazole Compound Example (6)) was changed to 5% by mass relative to the amount of the radical polymerizable hole-transporting compound.

### Example 13

An electrophotographic photoconductor was produced in the same manner as in Example 9, except that the addition amount of the oxazole compound (Oxazole Compound Example (6)) was changed to 10% by mass relative to the amount of the radical polymerizable hole-transporting compound.

### Example 14

An electrophotographic photoconductor was produced in the same manner as in Example 9, except that the addition amount of the oxazole compound (Oxazole Compound Example (6)) was changed to 15% by mass relative to the amount of the radical polymerizable hole-transporting compound.

### Comparative Examples 1 to 8

Electrophotographic photoconductors were produced in the same manner as in Examples 1 to 8, except that each of the oxazole compounds was not used.

### Comparative Example 9

An electrophotographic photoconductor was produced in the same manner as in Example 1, except that an ultraviolet absorbent (UV-1) having the following Structural Formula was added instead of the oxazole compound.

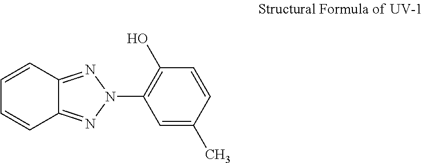 [SMILES: Cc1ccc(O)c(-n2nc3ccccc3n2)c1]

### Comparative Example 10

An electrophotographic photoconductor was produced in the same manner as in Example 1, except that an ultraviolet absorbent (UV-2) having the following Structural Formula was added instead of the oxazole compound.

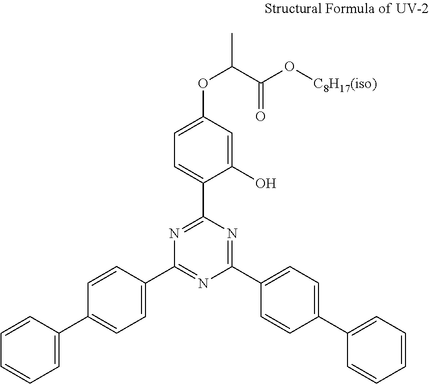

### Comparative Example 11

An electrophotographic photoconductor was produced in the same manner as in Example 1, except that a singlet oxygen quencher (Q-1) having the following Structural Formula was added instead of the oxazole compound.

### (Structure of Q-1)

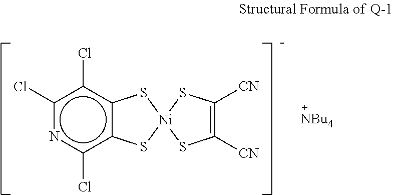

### <Effect of Suppressing Generation of Charge Trapping Due to Addition of Oxazole Compound>

Charge trapping generated in a protective layer makes the transfer of holes slow and/or stopped, and therefore it causes degradation in photosensitivity of the resulting photoconductor and an increase in residual potential. When a photoconductor that is negatively charged at a uniform potential level is irradiated with a light beam, holes generated in a charge generating layer are transferred to a hole transporting layer and a hole transporting protective layer to reach the surface of the photoconductor, causing the surface potential to dissipate.

As the surface potential dissipates, an electric field applied to the photoconductor becomes small in intensity. Thus, the hole transferability gradually becomes sluggish, and the surface potential is no longer decreased. The potential at this time is defined as a saturated potential.

When charge trapping is generated in the hole transporting-protective layer, the surface potential is all the more decreased. Thus, the saturated potential increases. Then, saturation potentials of each of the photoconductors were examined, and thereby whether generation of charge trapping is suppressed or not was evaluated.

Each of the electrophotographic photoconductors obtained in Examples 1 to 8 and each of the electrophotographic photoconductors obtained in Comparative Examples 1 to 8 each containing no oxazole compound, produced correspond to these Examples, was charged at −800 V by a scorotron charger while being rotated at a linear speed of 160 mm/sec, and irradiated with a semiconductor laser (aperture: 70 μm×80 μm; resolution: 400 dpi) having a wavelength of 655 nm. A surface potential of the electrophotographic photoconductor after 80 msec after the irradiation was measured. When a surface potential is measured while gradually increasing the quantity of light, the surface potential is not longer decreased at a certain quantity of light or more. This time, a surface potential obtained when the photoconductor surface was irradiated with a quantity of light sufficient to be saturated, i.e., 1 μJ/cm² was measured as a saturated potential. The results are shown in Table 2.

TABLE 2

| | Saturated |
|---|---|
| | potential (−V) |
| Ex. 1 | 118 |
| Ex. 2 | 109 |
| Ex. 3 | 103 |
| Ex. 4 | 95 |
| Ex. 5 | 90 |
| Ex. 6 | 87 |
| Ex. 7 | 117 |
| Ex. 8 | 120 |
| Comp. Ex. 1 | 220 |
| Comp. Ex. 2 | 208 |
| Comp. Ex. 3 | 201 |
| Comp. Ex. 4 | 129 |
| Comp. Ex. 5 | 135 |
| Comp. Ex. 6 | 124 |
| Comp. Ex. 7 | 220 |
| Comp. Ex. 8 | 241 |

In comparison with the saturated potential of each of the systems containing no oxazole compound in the above-mentioned various photoconductor compositions, the saturated potential of each of the systems containing an oxazole compound became small.

From this result, it was found that the oxazole compounds suppressed generation of charge trapping.

### <Influence of Addition Amount of Oxazole Compound>

The oxazole compounds for use in the present invention do not have hole transportability nor radical reactivity. Thus, it is contemplated that an increase in the oxazole compound content causes degradation in the hole transportability and the mechanical strength, and a decrease in the oxazole compound content causes a reduction of the effect of suppressing generation of charge trapping. Therefore, it is contemplated that there is an appropriated range of the oxazole compound content.

To determine this contemplation, the saturated potential and an elastic displacement τ serving as an indicator of the mechanical strength of each of the electrophotographic photoconductors containing a different amount of the addition amount of the oxazole compound were measured.

Using the electrophotographic photoconductors obtained in Examples 9 to 14 and Comparative Example 4, each saturated potential value determined in the same manner and each elastic displacement rate τe determined by the measurement method of an elastic displacement rate by means of the microscopic surface hardness meter are shown in Table 3.

TABLE 3

| | Addition | Saturated | Elastic |
|---|---|---|---|
| | amount | potential | displacement |
| | (% by mass) | (−V) | rate τe (%) |
| Ex. 9 | 0.3 | 121 | 45 |
| Ex. 10 | 0.5 | 104 | 44 |
| Ex. 11 | 1 | 91 | 44 |
| Ex. 12 | 5 | 83 | 42 |
| Ex. 13 | 10 | 81 | 40 |
| Ex. 14 | 15 | 81 | 34 |
| Comp. Ex. 4 | 0 | 129 | 45 |

From the results shown in Table 3, it was found that the saturated potential depends, in a certain extent, on the addition amount of the oxazole compound.

In comparison with the photoconductor of Comparative Example 4 containing no oxazole compound, the saturated potential of the electrophotographic photoconductor in which the addition amount of the oxazole compound was less than 0.5% by mass hardly varied and the effect of suppressing generation of charge trapping was not observed. Meanwhile, it was also found that the saturated potential of the electrophotographic photoconductors in which the addition amount of the oxazole compound was more than 10% by mass was no longer deceased and thus the oxazole compound was excessively added.

Along with an increase of the addition amount of the oxazole compound, the elastic displacement rate had a tendency to decrease. This shows that the presence of additives having no radical reactivity leads to a decrease in crosslink density. However, to the extent of the addition amount to 10% by mass, the electrophotographic photoconductor has an elastic displacement rate of 40% or higher, and has a sufficient mechanical strength, as compared to the photoconductor having no protective layer. However, when the addition amount of the oxazole compound is more than 10% by mass, the elastic displacement rate results in less than 40%, and it cannot be said that the protective layer has a sufficient strength.

From the examination described above, in order to provide a photoconductor having a sufficient mechanical strength as a protective layer, less causing charge trapping as well as excellent in charge transportability, it is found appropriate that the oxazole compound be added in an amount of 0.5% by mass to 10% by mass relative to the amount of the radical polymerizable holt transporting compound.

### <Influence on In-Plane Nonuniformity of Image Density During Continuous Outputting>

It was found that generation of charge trapping in a protective layer can be reduced by addition of a specific oxazole compound. Next, how each electrophotographic photoconductor had the above-mentioned effect to the in-plane nonuniformity of image density in practical image outputting was evaluated.

Each of the electrophotographic photoconductors produced in Examples 1 to 8 and Comparative Examples 1 to 8 was attached to a process cartridge of a digital full-color complex machine MP C7500 SP manufactured by Ricoh Company Ltd., and the process cartridge was mounted onto the main body of the complex machine. Then, using a test pattern having each intermediate tone of yellow, magenta, cyan and black, the test pattern image was continuously output on 500 sheets of A4 paper, Ricoh My Recycle Paper GP, at a resolution of 600×600 dpi and a printing speed of 60 sheets per minute. The first output image sheet to the fifth output image sheet and the 495^{th} output image sheet to the 500^{th} output image sheet were arranged and visually observed to evaluate the in-plane nonuniformity of image density. In addition, the image density of the intermediate tone pattern portion (1-by-1 dot-black image portion) of the first output image sheet and the 500^{th} output image sheet was measured by a Macbeth densitometer, and a change in image density between the image density measured at the start of the printing and the image density measured at the end of the printing was examined.

Note that the image density was determined by measuring 5 points and averaging the measured values.

### (Rank of In-Plane Nonuniformity)

Rank 5: Nonuniformity of image density was not observed. Rank 4: Nonuniformity of image density was hardly observed.
Rank 3: A slight amount of nonuniformity of image density was observed at part of the image.
Rank 2: A slight amount of nonuniformity of image density was observed throughout the image.
Rank 1: Nonuniformity of image density was clearly observed throughout the image.

The results are shown in Table 4.

TABLE 4

| | In-plane | In-plane | | | |
|---|---|---|---|---|---|
| | nonuniformity | nonuniformity | | Image | |
| | of image | of image | Image | density | |
| | density (1st | density | density | of | |
| | output sheet | (495th output | of 1st | 500th | Difference |
| | to 5th output | sheet to 500th | output | output | in image |
| | sheet) | output sheet) | sheet | sheet | density |
| Ex. 1 | 5 | 4 | 0.458 | 0.447 | 0.011 |
| Ex. 2 | 5 | 5 | 0.459 | 0.445 | 0.014 |
| Ex. 3 | 5 | 5 | 0.460 | 0.446 | 0.014 |
| Ex. 4 | 5 | 5 | 0.459 | 0.444 | 0.015 |
| Ex. 5 | 5 | 5 | 0.461 | 0.449 | 0.012 |
| Ex. 6 | 5 | 5 | 0.457 | 0.447 | 0.010 |
| Ex. 7 | 5 | 4 | 0.460 | 0.448 | 0.012 |
| Ex. 8 | 5 | 4 | 0.465 | 0.451 | 0.014 |
| Comp. | 4 | 3 | 0.458 | 0.433 | 0.025 |
| Ex. 1 | | | | | |
| Comp. | 4 | 3 | 0.459 | 0.431 | 0.028 |
| Ex. 2 | | | | | |
| Comp. | 4 | 3 | 0.459 | 0.435 | 0.024 |
| Ex. 3 | | | | | |
| Comp. | 4 | 3 | 0.455 | 0.430 | 0.025 |
| Ex. 4 | | | | | |
| Comp. | 4 | 3 | 0.456 | 0.436 | 0.020 |
| Ex. 5 | | | | | |
| Comp. | 4 | 3 | 0.457 | 0.431 | 0.026 |
| Ex. 6 | | | | | |
| Comp. | 4 | 3 | 0.453 | 0.435 | 0.018 |
| Ex. 7 | | | | | |
| Comp. | 4 | 3 | 0.458 | 0.433 | 0.025 |
| Ex. 8 | | | | | |

As described above, the electrophotographic photoconductors (Examples 1 to 8) had less in-plane nonuniformity of image density and enabled outputting high quality images as compared with the electrophotographic photoconductors (Comparative Examples 1 to 8) in which additives were not added. In addition, the image density of Examples 1 to 8 were maintained high even after outputting a large amount of images at high speed, and it was found that a change in image density of an intermediate tone image portion between the first output sheet and the 500^{th} output sheet apparently decreased, and stable outputting of images with time was ensured.

Since this tendency was observed depending on the presence or absence of additives, not depending on the size of saturated potential values, this suggests that the change in image density with time and in-plane image nonuniformity during image outputting are attributable to the amount of charge trapping present in the protective layer.

Therefore, this demonstrates that the electrophotographic photoconductor of the present invention, which is capable of suppressing generation of charge trapping by adding a specific oxazole compound, is effective to provide an image outputting method, an image outputting apparatus and a process cartridge for use in the image outputting apparatus in the commercial printing field in which high quality image and image stability are required.

<Comparison with Other Types of Additives>

The important function of the oxazole compound of the present invention is to suppress decomposition of a radical polymerizable-hole transporting compound during irradiation of an active energy beam such as an ultraviolet ray and an electron beam. A difference in result between the above-mentioned case and the case where an ultraviolet ray absorbent which is known to have a similar function to that described above was evaluated.

In addition, a difference in result between the above-mentioned case and the case where a singlet oxygen quencher effective in preventing discoloration of coloring materials, was added to the composition was also evaluated.

Saturated potential values of the photoconductors obtained in Comparative Examples 9 to 11 were measured in the same manner as described above. The measurement results are shown in Table 5.

TABLE 5

| | Saturated Potential (−V) |
|---|---|
| Comp. Ex. 9 | 251 |
| Comp. Ex. 10 | 234 |
| Comp. Ex. 11 | 761 |

As described above, the effect of reducing a saturated potential was not observed in the photoconductors of Comparative Examples 9 to 11 and some of them had an increase in saturated potential, as compared to the photoconductor of Comparative Example 1, and it was found that these photoconductors have large side effects to charge transportability.

These results show that the effect of the oxazole compound for use in the present invention is not a common effect.

The effects of the present invention has been described herein with reference to examples using ultraviolet ray as an active energy beam, and in the case where another active energy beam such as an electron beam is used, the function of stimulating deactivation from an excited state of the radical polymerizable-hole transporting compound and suppressing decomposition thereof also works, and thus similar effects can be exhibited.

### REFERENCE SIGNS LIST

1: photoconductor
2: charge eliminating lamp
3: charger
5: image exposure portion
6: developing unit
7: pre-transfer charger
8: registration roller
9: transferer
10: transfer charger
11: separation charger
12: separation claw
13: pre-cleaning charger
14: fur brush
15: cleaning blade
31: conductive support
33: photosensitive layer
35: charge generating layer
37: hole transporting layer
39: hole transporting-protective layer
101: photoconductor
102: charging unit
103: exposing unit
104: developing unit
105: transferer
106: transfer unit
107: cleaning unit

1. An electrophotographic photoconductor, comprising:
a conductive support,
a charge generating layer laminated on the conductive support,
a hole transporting layer laminated on the charge generating layer, and
a hole transporting protective layer laminated on the hole transporting layer,
wherein the hole transporting protective layer comprises a three-dimensionally crosslinked product obtained by a process comprising chain-polymerizing a radical polymerizable hole transporting compound by irradiating with an active energy beam and
the hole transporting protective layer comprises an oxazole compound of Formula (1) or Formula (2): 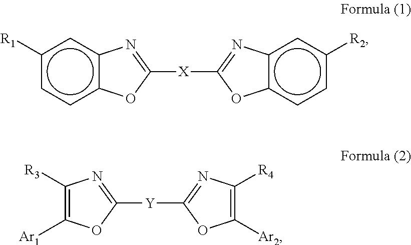
wherein R₁ and R₂ are each independently a hydrogen atom or an alkyl group having from 1 to 4 carbon atoms;
X is a vinylene group, a divalent group of an aromatic hydrocarbon having from 6 to 14 carbon atoms, or a 2,5-thiophendiyl group;
Ar₁ and Ar₂ are each independently a univalent group of an aromatic hydrocarbon having from 6 to 14 carbon atoms;
Y is a divalent group of an aromatic hydrocarbon having from 6 to 14 carbon atoms; and
R₃ and R₄ are each independently a hydrogen atom or a methyl group.

2. The electrophotographic photoconductor of claim 1, wherein an amount of the oxazole compound in the hole transporting protective layer is from 0.5% to 10% by mass relative to an amount of the radical polymerizable hole transporting compound.

3. The electrophotographic photoconductor of claim 1, wherein a radical polymerizable reaction group in the radical polymerizable hole transporting compound is an acryloyloxy group.

4. An image forming method, comprising:
repeatedly charging;
image-exposing;
developing; and
image-transferring, with an electrophotographic photoconductor,
wherein the electrophotographic photoconductor comprises:
a conductive support,
a charge generating layer laminated on the conductive support,
a hole transporting layer laminated on the charge generating layer, and
a hole transporting protective layer laminated on the hole transporting layer,
wherein the hole transporting protective layer comprises a three-dimensionally crosslinked product obtained by a process comprising chain-polymerizing a radical polymerizable hole transporting compound by irradiating with an active energy beam, and
the hole transporting protective layer comprises an oxazole compound of Formula (1) or Formula (2): 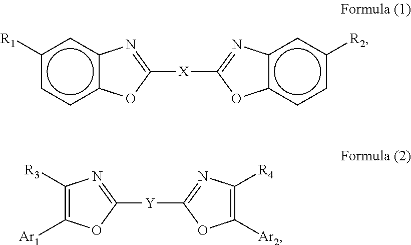
wherein R₁ and R₂ are each independently a hydrogen atom or an alkyl group having from 1 to 4 carbon atoms;
X is a vinylene group, a divalent group of an aromatic hydrocarbon having from 6 to 14 carbon atoms, or a 2,5-thiophendiyl group,
Ar₁ and Ar₂ are each independently a univalent group of an aromatic hydrocarbon having from 6 to 14 carbon atoms;
Y is a divalent group of an aromatic hydrocarbon having from 6 to 14 carbon atoms; and
R₃ and R₄ are each independently a hydrogen atom or a methyl group.

5. An image forming apparatus comprising an electrophotographic photoconductor, comprising:
a conductive support,
a charge generating layer laminated on the conductive support,
a hole transporting layer laminated on the charge generating layer, and
a hole transporting protective layer laminated on the hole transporting layer,
wherein the hole transporting protective layer comprises a three-dimensionally crosslinked product obtained by a process comprising chain-polymerizing a radical polymerizable hole transporting compound by irradiating with an active energy beam and
the hole transporting protective layer comprises an oxazole compound of Formula (1) or Formula (2): 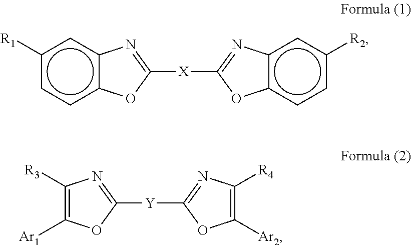
wherein R₁ and R₂ are each independently a hydrogen atom or an alkyl group having from 1 to 4 carbon atoms,
X is a vinylene group, a divalent group of an aromatic hydrocarbon having from 6 to 14 carbon atoms, or a 2,5-thiophendiyl group,
Ar₁ and Ar₂ are each independently a univalent group of an aromatic hydrocarbon having from 6 to 14 carbon atoms,
Y is a divalent group of an aromatic hydrocarbon having from 6 to 14 carbon atoms; and
R₃ and R₄ are each independently a hydrogen atom or a methyl group.

6. (canceled)

7. The electrophotographic photoconductor of claim 1, wherein R₁, R₂ or both is or are a methyl group, an ethyl group, an n-propyl group, an iso-propyl group, an n-butyl group, an iso-butyl group, a sec-butyl group, or tert-butyl group.

8. The method of claim 4, wherein R₁, R₂ or both is or are a methyl group, an ethyl group, an n-propyl group, an iso-propyl group, an n-butyl group, an iso-butyl group, a sec-butyl group, or tert-butyl group.

9. The apparatus of claim 5, wherein R₁, R₂ or both is or are a methyl group, an ethyl group, an n-propyl group, an iso-propyl group, an n-butyl group, an iso-butyl group, a sec-butyl group, or tert-butyl group.

10. The electrophotographic photoconductor of claim 1, wherein X is an o-phenylene group, a p-phenylene group, a 1,4-naphthalenediyl group, a 2,6-naphthalenediyl group, a 9,10-anthracenediyl group, a 1,4-anthracenediyl group, a 4,4′-bisphenyldiyl group, or a 4,4′-stilbenediyl group.

11. The method of claim 4, wherein X is an o-phenylene group, a p-phenylene group, a 1,4-naphthalenediyl group, a 2,6-naphthalenediyl group, a 9,10-anthracenediyl group, a 1,4-anthracenediyl group, a 4,4′-bisphenyldiyl group, or a 4,4′-stilbenediyl group.

12. The apparatus of claim 5, wherein X is an o-phenylene group, a p-phenylene group, a 1,4-naphthalenediyl group, a 2,6-naphthalenediyl group, a 9,10-anthracenediyl group, a 1,4-anthracenediyl group, a 4,4′-bisphenyldiyl group, or a 4,4′-stilbenediyl group.

13. The electrophotographic photoconductor of claim 1, wherein Ar₁, Ar₂, or both is or are an aromatic hydrocarbon group such as a phenyl group, a 4-methylphenyl group, a 4-tert-butylphenyl group, a naphthyl group, or a biphenylyl group.

14. The method of claim 4, wherein Ar₁, Ar₂, or both is or are an aromatic hydrocarbon group such as a phenyl group, a 4-methylphenyl group, a 4-tert-butylphenyl group, a naphthyl group, or a biphenylyl group.

15. The apparatus of claim 5, wherein Ar₁, Ar₂, or both is or are an aromatic hydrocarbon group such as a phenyl group, a 4-methylphenyl group, a 4-tert-butylphenyl group, a naphthyl group, or a biphenylyl group.

16. The electrophotographic photoconductor of claim 1, wherein Y is an o-phenylene group, a p-phenylene group, a 1,4-naphthalenediyl group, a 2,6-naphthalenediyl group, a 9,10-anthracenediyl group, a 1,4-anthracenediyl group, a 4,4′, bisphenyldiyl group, and a 4,4′-stilbenediyl group.

17. The method of claim 4, wherein Y is an o-phenylene group, a p-phenylene group, a 1,4-naphthalenediyl group, a 2,6-naphthalenediyl group, a 9,10-anthracenediyl group, a 1,4-anthracenediyl group, a 4,4′-bisphenyldiyl group, and a 4,4′-stilbenediyl group.

18. The apparatus of claim 5, wherein Y is an o-phenylene group, a p-phenylene group, a 1,4-naphthalenediyl group, a 2,6-naphthalenediyl group, a 9,10-anthracenediyl group, a 1,4-anthracenediyl group, a 4,4′-bisphenyldiyl group, and a 4,4′-stilbenediyl group.
